(19) United States
(12) Patent Application Publication
(10) Pub. No.: US 2025/0348910 A1
(43) Pub. Date: Nov. 13, 2025

(54) ADVERTISEMENT MATCHING FOR GENERATIVE ARTIFICIAL INTELLIGENCE/MACHINE LEARNING (AI/ML) MODELS

(71) Applicant: QUALCOMM Incorporated, San Diego, CA (US)

(72) Inventors: Michael Franco TAVEIRA, San Diego, CA (US); Vikram GUPTA, San Diego, CA (US)

(21) Appl. No.: 19/204,428

(22) Filed: May 9, 2025

Related U.S. Application Data
(60) Provisional application No. 63/645,828, filed on May 10, 2024.

(51) Int. Cl. G06Q 30/0241; G06T 5/77

(52) U.S. Cl. CPC G06Q 30/0276; G06Q 30/0277; G06T 5/77

(57) ABSTRACT

An apparatus has one or more memories and one or more processors coupled to the one or more memories. The one or more processors is configured to receive an input to a generative artificial intelligence/machine learning (AI/ML) model. The one or more processors is also configured to generate, with the generative AI/ML model, an output based on the input, the output comprising a generated image. The one or more processors is further configured to determine an advertisement related to at least one of the input or the output. The one or more processors is still further configured to display the advertisement and the output of the generative AI/ML model by displaying the advertisement and the output.

### CROSS-REFERENCE TO RELATED APPLICATION

The present application claims the benefit of U.S. Provisional Patent Application No. 63/645,828, filed on May 10, 2024, and titled “ADVERTISEMENT MATCHING FOR GENERATIVE ARTIFICIAL INTELLIGENCE/MACHINE LEARNING (AI/ML) MODELS,” the disclosure of which is expressly incorporated by reference in its entirety.

### FIELD OF THE DISCLOSURE

Aspects of the present disclosure generally relate to artificial neural networks, and more specifically to advertisement matching for generative artifical intelligence/machine learning (AI/ML) models.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, image generation, text generation, video generation, speech recognition, audio generation, acoustic scene classification, keyword spotting, autonomous driving, extended reality (XR), camera/video and other tasks.

Development and deployment of these artificial neural networks are associated with many costs. It would be desirable to generate and display relevant advertisements to offset some of these costs.

### SUMMARY

Aspects of the present disclosure are directed to an apparatus. The apparatus has one or more memories and one or more processors coupled to the memory. The processor(s) is configured to receive a text input to a generative artificial intelligence/machine learning (AI/ML) model. The processor(s) is also configured to generate, with the generative AI/ML model, a text output based on the text input. The processor(s) is further configured to determine an advertisement related to the text input and/or the text output. The processor(s) is still further configured to modify the text input and/or the text output with the advertisement. The processor(s) is also configured to display the advertisement while receiving the text input and/or while generating the text output by generating the advertisement for selected text of the text input and/or the text output.

Other aspects of the present disclosure are directed to an apparatus. The apparatus has one or more memories and one or more processors coupled to the memory. The processor(s) is configured to receive an input to a generative artificial intelligence/machine learning (AI/ML) model. The processor(s) is also configured to generate, with the generative AI/ML model, an output based on the input, the output comprising a generated image. The processor(s) is further configured to determine an advertisement related to the input and/or the output. The processor(s) is still further configured to display the advertisement and the output of the generative AI/ML model by displaying the advertisement and the output.

In other aspects of the present disclosure, a processor-implemented method includes receiving a text input to a generative artificial intelligence/machine learning (AI/ML) model. The method also includes generating, with the generative AI/ML model, a text output based on the text input. The method further includes determining an advertisement related to the text input and/or the text output. The method still further includes modifying the text input and/or the text output with the advertisement. The method also includes displaying the advertisement while receiving the text input and/or while generating the text output by generating the advertisement for selected text of the text input and/or the text output.

In other aspects of the present disclosure, a processor-implemented method includes receiving an input to a generative artificial intelligence/machine learning (AI/ML) model. The method also includes generating, with the generative AI/ML model, an output based on the input, the output comprising a generated image. The method further includes determining an advertisement related to the input and/or the output. The method still further includes displaying the advertisement and the output of the generative AI/ML model by displaying the advertisement and the output.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with various aspects of the present disclosure.

FIG. 2D is a diagram illustrating an exemplary deep convolutional network (DCN), in accordance with various aspects of the present disclosure.

FIG. 3 is a block diagram illustrating an exemplary deep convolutional network (DCN), in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a block diagram illustrating advertisement placement based on a user profile, sensor data, usage context, and prompts, in accordance with various aspects of the present disclosure.

FIG. 6 is a block diagram illustrating advertisement placement based on a user profile, sensor data, usage context, and prompts, in accordance with various aspects of the present disclosure.

FIG. 7 is a block diagram illustrating text-based advertisement placement, in accordance with various aspects of the present disclosure.

FIG. 8 is a block diagram illustrating text-based advertisement placement, in accordance with various aspects of the present disclosure.

FIG. 9 is a block diagram illustrating text-based advertisement placement, in accordance with various aspects of the present disclosure.

FIG. 10 is a block diagram illustrating banner advertisement placement using context, in accordance with various aspects of the present disclosure.

FIG. 11 is a block diagram illustrating banner advertisement placement using context, in accordance with various aspects of the present disclosure.

FIG. 12 is a block diagram illustrating banner advertisement placement using context, in accordance with various aspects of the present disclosure.

FIG. 13 is a block diagram illustrating content generation model fine tuning using advertising provided datasets, in accordance with various aspects of the present disclosure.

FIG. 14 is a block diagram illustrating content generation model fine tuning using advertising provided datasets, in accordance with various aspects of the present disclosure.

FIG. 15 is a block diagram illustrating low rank adapter (LoRA) content generation using advertising provided datasets, in accordance with various aspects of the present disclosure.

FIG. 16 is a block diagram illustrating low rank adapter content generation using advertising provided datasets, in accordance with various aspects of the present disclosure.

FIG. 17 is a block diagram illustrating personalization of low rank adapter content, in accordance with various aspects of the present disclosure.

FIG. 18 is a block diagram illustrating in-painting brand placement, in accordance with various aspects of the present disclosure.

FIG. 19 is a block diagram illustrating highlighted content attribution, in accordance with various aspects of the present disclosure.

FIG. 20 is a block diagram illustrating paired advertisements, in accordance with various aspects of the present disclosure.

FIG. 21 is a flow diagram illustrating a processor-implemented method for advertisement matching for generative artificial intelligence/machine learning (AI/ML) models, in accordance with various aspects of the present disclosure.

FIG. 22 is a flow diagram illustrating a processor-implemented method for advertisement matching for generative artificial intelligence/machine learning (AI/ML) models, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Various types of artificial neural networks (ANNs) include generative models and applications, such as (but not limited to) diffusion models, large language models (LLMs), and chatbots, for example. Developing and deploying these models is expensive. It would be desirable to reduce costs and/or profit from operating the models. Advertisements, or other matched content or directed or intentional content, present a solution for LLMs and other generative model economies. Advertisements are used as an example in many aspects, but other forms of content that are matched to a user, input, environment or context, etc., or are directed or intentionally included in a user interface, results, model output, etc., by a designer of the model or system or by a third party (such as an outside company or sponsor) may alternatively or additionally be implemented.

According to aspects of the present disclosure, responses/outputs of an artificial intelligence/machine learning (AI/ML) model and/or prompts into the AI/ML model may use advertisement (or “ad,” hereinafter used interchangeably) matching or other techniques to create ad matching opportunities. Ads may be presented at any time during the process of a user typing a query until the user receives a response from the AI/ML model. In some aspects, while a user waits for a response to start or be completed, ads may be presented anywhere on screen because the system has the user's attention at that time. In these aspects, the ad(s) is/are presented while the response is being output, as opposed to after the response is completely output. Although the present disclosure primarily discusses ads, content in any form that is being matched/selected in the described manner is contemplated. Ads (e.g., video, images, etc.) are just one example of content.

Prompts into the AI/ML model may be modified, or they may remain unchanged. The prompts may be modified on any device, for example, on-device (e.g., the user's device, the edge device, etc.), with an intermediary device, on a server with the main AI/ML model, etc. Responses from the AI/ML model may be modified, or may remain unchanged. The responses may be modified on any device, for example, on-device, with an intermediary device, on a server with the main AI/ML model, etc.

Ads may also be presented during further iterations by the user and the model. According to these aspects of the present disclosure, if multiple responses or drafts are requested (e.g., the user did not like the response), a new response can again be based on the same ad match as the original response. In other aspects, the ad match may be based on a new ad match, for example, a different product or another match opportunity, such as a name brand of a different item. In still further aspects, the new response may be free of any ad matching.

In some examples, advertisers may be provided with a tool or other software for AI/ML model optimization. The advertisers may train any model with the tool. In some aspects, the advertiser's tool may be configured to receive an input, for example, a brand name and a series of words/phrases, and populate a set of words, phrases, usage, etc., for training.

Instead of (or in addition to) inserting a particular brand (such as brand X), a response may be modified to include subliminal messages or cues. For example, instead of (or in addition to) presenting an ad for “TIDE,” the response may incorporate the words “ocean” and “moon” and/or the like. Thus, instead of presenting the matched content directly (e.g., the ad is the matched content and the ad word is directly presented) as in most of the described embodiments, term(s) or object(s) may be presented instead that correspond to the matched content.

Particular aspects of the subject matter described in this disclosure can be implemented to realize one or more of the following potential advantages. In some examples, the described advertising matching techniques for generative AI/ML models may generate revenue to offset costs associated with development and deployment of AI/ML models. Thus, users may be able to freely use a generative AI/ML model because their use may be subsidized by ads. Alternatively, users may pay for an ad-free or reduced ad experience, which may also help to offset costs.

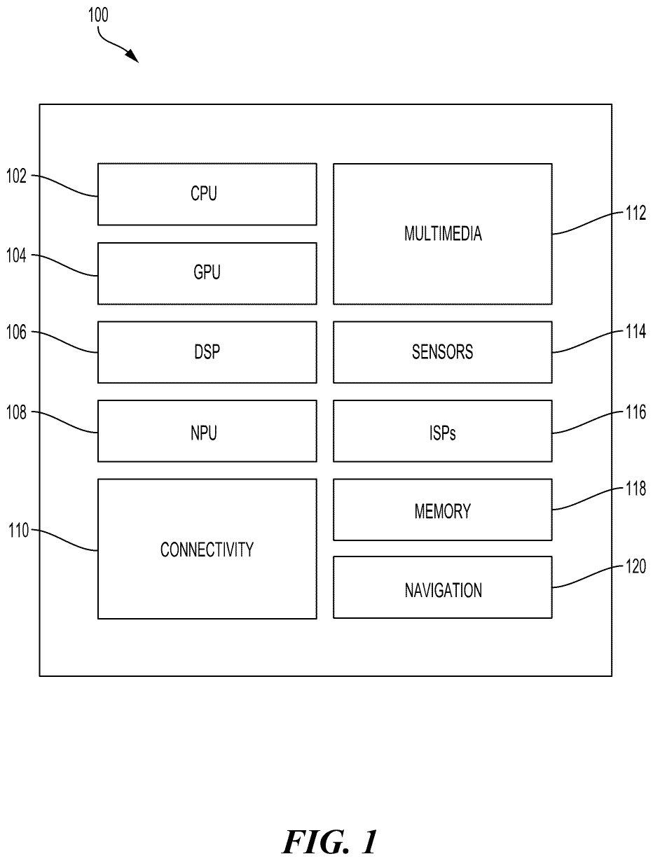

FIG. 1 illustrates an example implementation of a system-on-a-chip (SOC) 100, which may include a central processing unit (CPU) 102 or a multi-core CPU configured for presenting advertisements while receiving generative artificial intelligence/machine learning (AI/ML) model input and/or while generating AI/ML model output. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, WI-FI connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive a text input to a generative artificial intelligence/machine learning (AI/ML) model. The general-purpose processor 102 may also include code to generate, with the generative AI/ML model, a text output based on the text input. The general-purpose processor 102 may further include code to determine an advertisement related to the text input and/or the text output. The general-purpose processor 102 may still further include code to modify the text input and/or the text output with the advertisement. The general-purpose processor 102 may also include code to display the advertisement while receiving the text input and/or while generating the text output by generating the advertisement for selected text of the text input and/or the text output.

In aspects of the present disclosure, the instructions loaded into the general-purpose processor 102 may include code to receive an input to a generative artificial intelligence/machine learning (AI/ML) model. The general-purpose processor 102 may also include code to generate, with the generative AI/ML model, an output based on the input, the output comprising a generated image. The general-purpose processor 102 may further include code to determine an advertisement related to the input and/or the output. The general-purpose processor 102 may still further include code to display the advertisement and the output of the generative AI/ML model by displaying the advertisement and the output.

In some aspects, the general-purpose processor 102 may include means for receiving, means for generating, means for determining, means for modifying, means for displaying, means for preventing, means for blocking, and means for injecting.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

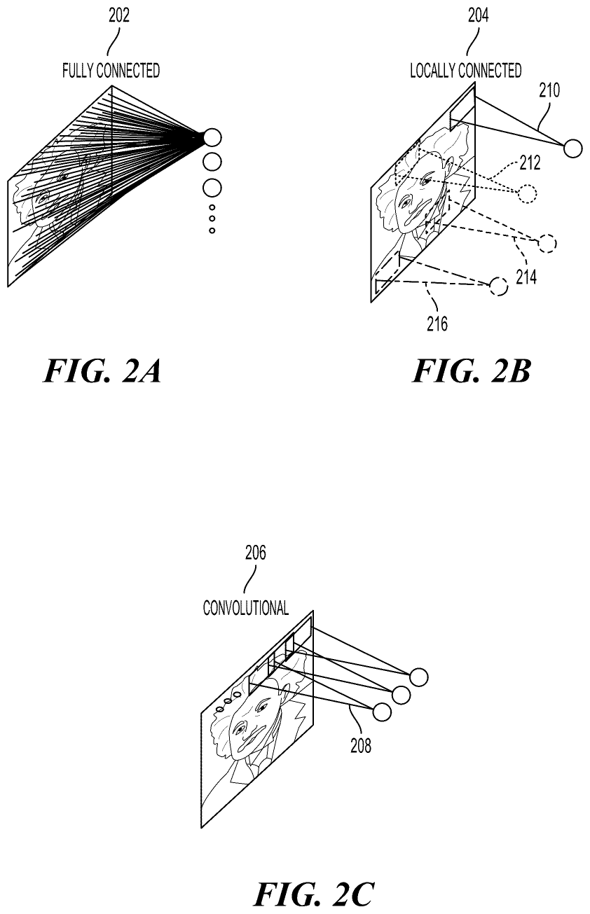

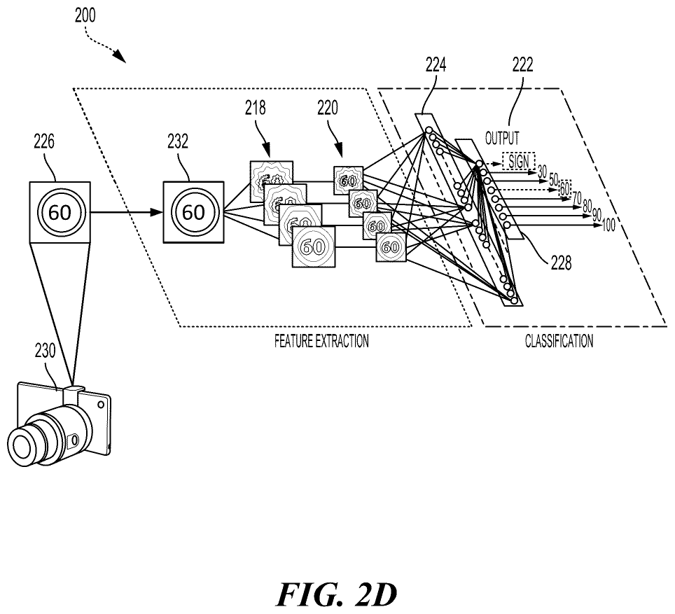

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

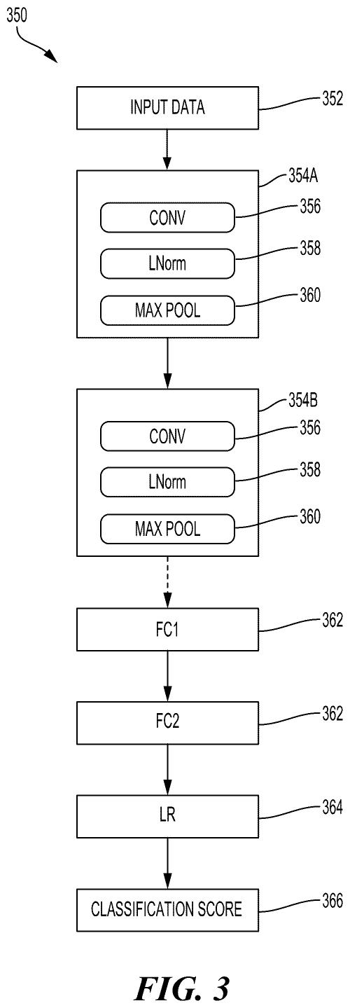

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

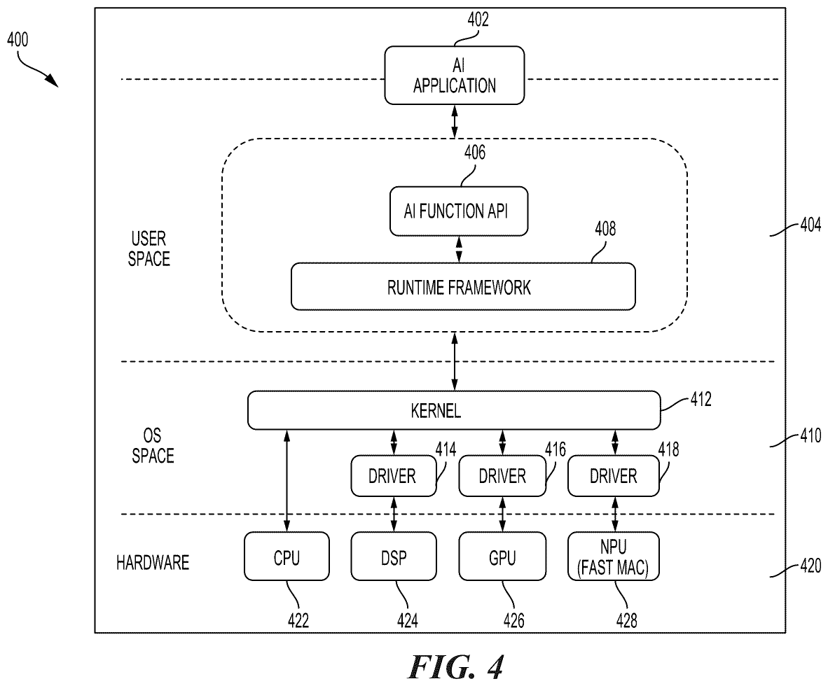

FIG. 4 is a block diagram illustrating an exemplary software architecture 400 that may modularize artificial intelligence (AI) functions. Using the architecture 400, applications may be designed that may cause various processing blocks of an SOC 420 (for example, a CPU 422, a DSP 424, a GPU 426 and/or an NPU 428) (which may be similar to SOC 100 of FIG. 1) to receive a text input to a generative artificial intelligence/machine learning (AI/ML) model for an AI application 402, according to aspects of the present disclosure. Applications may also be designed that may cause various processing blocks of an SOC 420 to generate, with the generative AI/ML model, a text output based on the text input for an AI application 402, according to aspects of the present disclosure. Applications may further be designed that may cause various processing blocks of an SOC 420 to determine an advertisement related to the text input and/or the text output for an AI application 402, according to aspects of the present disclosure. Applications may still further be designed that may cause various processing blocks of an SOC 420 to modify the text input and/or the text output with the advertisement for an AI application 402, according to aspects of the present disclosure. Applications may also be designed that may cause various processing blocks of an SOC 420 to display the advertisement while receiving the text input and/or while generating the text output by generating the advertisement for selected text of the text input and/or the text output for an AI application 402, according to aspects of the present disclosure. The architecture 400 may, for example, be included in a computational device, such as a smartphone.

Using the architecture 400, applications may be designed that may cause various processing blocks of an SOC 420 (for example, a CPU 422, a DSP 424, a GPU 426 and/or an NPU 428) (which may be similar to SOC 100 of FIG. 1) to receive an input to a generative artificial intelligence/machine learning (AI/ML) model for an AI application 402, according to aspects of the present disclosure. Applications may also be designed that may cause various processing blocks of an SOC 420 to generate, with the generative AI/ML model, an output based on the input, the output comprising a generated image for an AI application 402, according to aspects of the present disclosure. Applications may further be designed that may cause various processing blocks of an SOC 420 to determine an advertisement related to the input and/or the output for an AI application 402, according to aspects of the present disclosure. Applications may still further be designed that may cause various processing blocks of an SOC 420 to display the advertisement and the output of the generative AI/ML model by injecting the advertisement as a first image into the output for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Various types of artificial neural networks include generative models and applications, such as (but not limited to) diffusion models, large language models (LLMs), and chatbots, for example. Developing and deploying these models is expensive. It would be desirable to reduce costs and/or to generate profit from operating the models. Advertisements, as well as other forms of matched, directed, or intentional content, offer a potential solution for monetizing LLMs and other generative models.

According to aspects of the present disclosure, responses/outputs of an AI/ML model and/or prompts for the AI/ML model may use ad matching or other techniques to create ad matching opportunities. For example, a user prompt could be a question about how to make a mojito. The response from the AI/ML model may tell the user to use a particular brand (e.g., brand X rum) instead of just rum in the mojito recipe: “A mojito is made with brand X rum, mint . . . .”

Ads can be presented at any time during the process of a user typing a query until the user receives a response from the AI/ML model. Ads may also be presented during further iterations by the user and/or the model. According to various aspects, the “process” may mean, for instance, from the moment a user starts to type a character in the prompt field to just after the last character of the response or other output, such as an image, is complete.

In some aspects, while users wait for a response to start (e.g., time to first token) or be completed (e.g., tokens being presented but response/output not yet finished), ads may be presented anywhere on screen because the system has the user's attention at that time. The ads may or may not be related to the prompt and/or response. In these aspects, the ads are presented while the response is being output, as opposed to after the response is completely output. Aspects of the present disclosure are not limited to presenting multiple ads. In some examples, only one ad is presented. For ease of explanation, various aspects of the present disclosure describe presenting ads (e.g., advertisements) instead of an ad (e.g., an advertisement), although both are encompassed by the descriptions, regardless of whether explicitly recited.

In some examples, one or more advertisements may be presented while users wait for images to be drawn by an AI/ML image generator, as the wait times for image generation may be long. Ad serving opportunities exist during the time period for generating an image. That is, rather than being presented with a blank screen for the time period, such as ten to fifteen seconds, for example, a user may be presented with one or more ads. These opportunities are particularly valuable because the user is actively waiting (e.g., paying attention). In contrast, waiting to present an ad until after the output has been generated/provided may not catch as much of the attention of the user, who may have moved on to something else. However, aspects of the present disclosure are also directed to ads presented after an output. Further, in certain aspects, ads may be presented anywhere on a screen, or served in any other manner, such as an ad sound coming from a speaker of the user's device (or another device, such as a nearby smart speaker) or an ad presented on another device.

In some aspects, a smaller AI/ML model or a different type of model than the generative AI/ML model may generate and present the ad during the ad opportunity. The smaller/different AI/ML model in these aspects is not the same as the model that is causing the wait. Alternatively, conventional ad matching techniques may provide the ads.

There are numerous steps between receiving a prompt input and displaying a response. Opportunities for ad matching may exist at any of those steps. Additionally, ads may be displayed at any of those steps.

In a first non-limiting example, the user prompt is “how do I make a mojito?” The prompt may be modified on device, for example, by an ad module, with ad criteria, for example, “brand X rum,” and optionally any other text/data/information, for example, “with.” The modified prompt, for example, “how do I make a mojito with brand X rum?” may be sent to the main model, for example, an LLM or diffusion model, residing on a remote server/device in the usual manner.

In another example, an on-device ad module may analyze the prompt to select an ad selection output, for example, “brand X.” The device may send the user prompt and the ad selection to the main model to generate a response based on both inputs.

In still another example, the user prompt may be modified on a server, where the main model resides or on another remote device, for example, an edge device. Thus, the user device sends a prompt as usual, the server or intermediary device may then modify the prompt via an ad module. For example, the prompt may be modified to: “how do I make a mojito with brand X rum?” The ad module may reside on any device.

When modifying the input in accordance with any of these examples, the advertisement may be an image. Such an image may be generated while the prompt is being generated. For example, once enough of the prompt is entered to recognize what a relevant ad should be, the image may be generated.

In another example, the model on the server may receive both the user prompt and an ad module output as input. For example, “brand X” may be selected from among multiple options such that the model generates a response based on both the user prompt and the ad module output. In this example, the input itself is not modified, but rather the output is modified. In this example, the ad module may reside on any device.

In some aspects, responses are modified at the server or an intermediary device. For example, a user prompt may be sent to a server/model as usual. The main model generates a response, for example, “A mojito is made with rum, mint, . . . .” Then the ad module or model may modify the response: for example, “A mojito is made with brand X rum, mint, . . . ” (where “brand X” is added to the response). The modified response is eventually sent to the user. All processing in these aspects occurs in the cloud network. The ad module may again reside on any device.

In other aspects, the responses are modified on a user device. For example, a user prompt may be sent to the server/model as usual. The main model generates a response, for example, “A mojito is made with rum, mint, . . . ” and sends the response to the user device. Then, the user device, for example, via an ad module (which may be on the user device or be remotely accessed from a remote device/server), modifies the received response. In this example, the modified response is: “A mojito is made with brand X rum, mint, . . . .” The modified response is provided to the user. In some aspects, user preferences may be stored on the user device (or accessed from a remote device/server). In one example, the ad module may account for user preferences. The user preferences could include (but is not limited to) traits about the user, frequency of advertisements, types of advertisements, contexts in which advertisements are not allowed or are to be mitigated, contexts in which advertisements are allowed or may be increased, whitelists and/or blacklists of products or ads, etc.

Thus, in various aspects, prompts may be modified, while in other aspects, the prompts may remain unchanged. In various aspects, the prompts may be modified on any device, for example, on-device (e.g., the user's device, the edge device, etc.), on an intermediary device, on a server (e.g., containing the main AI/ML model), etc. In various aspects, responses may be modified, while in other aspects the responses may remain unchanged. In various aspects, the responses may be modified on any device, for example, on-device, on an intermediary device, on a server (e.g., containing the main AI/ML model), etc.

User characteristics or a user profile based on user characteristics may be fed to the AI/ML model at any appropriate point in the flow to provide more relevant ad matching in the results. Moreover, contextual information, for example, location, time, etc., may also be considered by the AI/ML model. In some aspects, some of this contextual information may be derived from one or more sensors associated with the user's device and/or other device associated with the user. For example, when the user is on vacation during a typical mealtime, the ad model may present an advertisement for food delivery from restaurants that are nearby or otherwise relevant to the user.

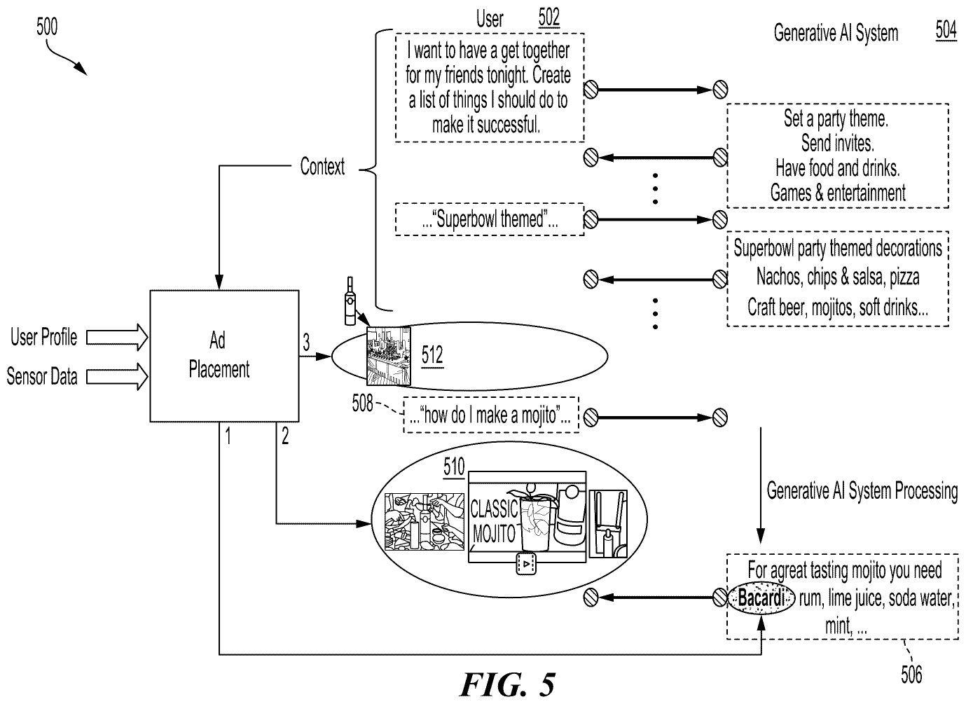

FIG. 5 is a block diagram illustrating an example 500 of advertisement placement based on a user profile, sensor data, usage context, and/or prompts, in accordance with various aspects of the present disclosure. User profile, sensor data, context information, and partial or completed prompts can be used for ads that contain personalized images, audio, video, and text. As seen in the example 500 of FIG. 5, a user 502 and a generative AI system 504 may interact. The user 502 states “I want to have a get together for my friends tonight. Create a list of things I should do to make it successful.” In response, the generative AI system 504 states “Set a party theme. Send invites. Have food and drinks. Games & entertainment.” The user 502 then states “Superbowl themed . . . ,” to which the generative AI system 504 responds “Superbowl party themed decorations; Nachos, chips & salsa, pizza; Craft beer, mojitos, soft drinks . . . .”

The interaction between the user 502 and the generative AI system 504 creates context that may enable ad placement. User profile data, as well as sensor data, may further influence the ad placement. The user profile, blacklist, and whitelist may be developed over a period of time based on ads that have been shown and how the user reacted to the ads. A whitelist is a list of items that will be approved. A blacklist is a list of items that will be prohibited. The user profile may include the whitelist, blacklist, as well as other data, such as demographic information, etc. The sensor data may be derived from one or more sensors associated with the user's device. Implementation details for the ad placement are described in examples below.

In a first option, 1, based on the interaction, user profile, and sensor data, the generative AI system 504 may generate a response 506 “For a great tasting mojito you need Bacardi rum, lime juice, soda water, mint, . . . .”

In a second option, 2, an ad 510 is placed while the user 502 is awaiting a response from the generative AI system 504. The ad may be in any format, such as a banner ad, a splash screen, etc. The ad 510 may be placed anywhere on the screen. In the second option, 2, the user 502 inputs a prompt 508 “how do I make a Mojito,” and the ad 510 is placed based on the context and the prompt 508. The ad 510 may be placed regardless of whether the prompt 508 is a partial or complete prompt. The ad 510 may be placed while the user 502 is waiting for a response 506 from the generative AI system 504.

In a third option, 3, the context alone may be used for placement of an ad, which may be in the form of a banner ad 512. The banner ad 512 may include an image of BACARDI rum, based on the context, which includes the prior interaction between the user 502 and the generative AI system 504. The three options described above may be deployed individually or multiple such options may be deployed.

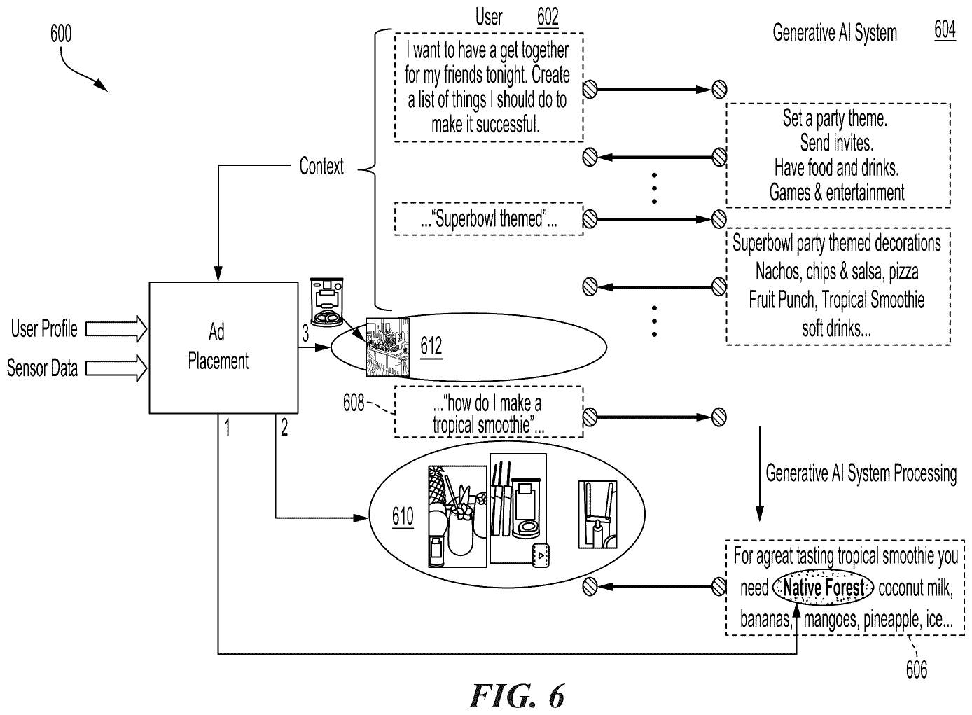

FIG. 6 is a block diagram illustrating an example 600 of advertisement placement based on a user profile, sensor data, usage context, and/or prompts, in accordance with various aspects of the present disclosure. Implementation details for the ad placement are described in examples below. As seen in the example 600 of FIG. 6, a user 602 and a generative AI system 604 may interact. The user 602 states “I want to have a get together for my child's friends tonight. Create a list of things I should do to make it successful.” In response, the generative AI system 604 states “Set a party theme. Send invites. Have food and drinks. Games & entertainment.” The user 602 then states “Superbowl themed . . . ,” to which the generative AI system 604 responds “Superbowl party themed decorations; Nachos, chips & salsa, pizza; fruit punch, tropical smoothie, soft drinks . . . .”

In a first option, 1, based on the interaction, user profile, and sensor data, the generative AI system 604 may generate a response 606 “For a great tasting tropical smoothie you need Native Forest coconut milk, bananas, mangoes, pineapple, ice, . . . .”

In a second option, 2, an ad 610 is placed while the user 602 is awaiting a response from the generative AI system 604. In the second option, 2, the user 602 inputs the prompt 608 “how do I make a tropical smoothie,” and the ad 610 is placed based on the context and the prompt 608. The ad 610 may be placed regardless of whether the prompt 608 is a partial or complete prompt. The ad 610 may be placed while the user 602 is waiting for a response 606 from the generative AI system 604.

In a third option, 3, the context alone may be used for placement of an ad, which may be in the form of a banner ad 612. The banner ad 612 may include an image of NATIVE FOREST coconut milk, based on the context, which includes the prior interaction between the user 602 and the generative AI system 604. The three options described above may be deployed individually or multiple such options may be deployed.

Additional aspects will now be described with respect to a generative model, such as a text generator or large language model (LLM) as the AI/ML model. The present disclosure, however, is not limited to any particular type of AI/ML model or any particular type of generative model. For example, image generators, video generators, and audio generators are also contemplated, among other models.

According to aspects of the present disclosure, a first LLM may be fine-tuned for ad matching. In other aspects, the first LLM (not tuned for ads) may work with a second LLM, which was fine-tuned for ad matching. In particular aspects, both/either case, the fine tuning may be based on ad matching techniques used in web searches, social networks, etc. In the second scenario, the second LLM may be part of or may be the ad module, according to some aspects.

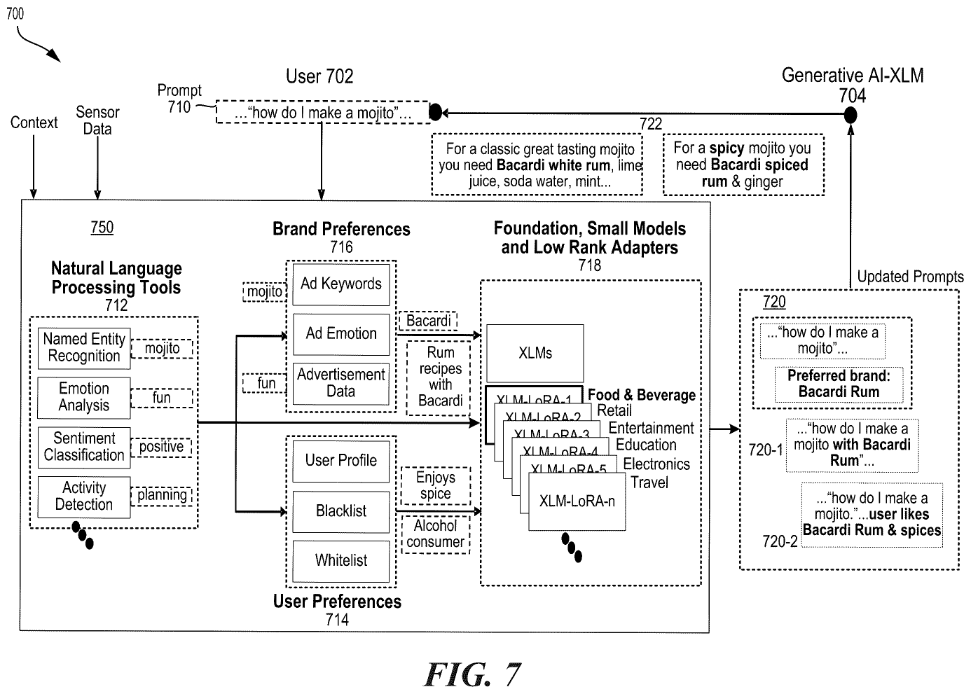

FIG. 7 is a block diagram illustrating an example 700 of text-based advertisement placement example 700, in accordance with various aspects of the present disclosure. In the example 700 of FIG. 7, an ad module 750 may modify (or update) a prompt 710 from a user 702, and/or supplement the prompt 710 with preferred brands using natural language processing (NLP) tools 712, user preferences 714, brand (e.g., advertiser) preferences 716, and (multimodal) foundation models and/or small models and their low rank adapter (LoRA) versions 718. Updated prompts 720 include ad placements. For example, a first updated prompt 720-1 may be based on a brand preference 716 of BACARDI and the original prompt 710. The brand preferences 716 may include ad keywords (e.g., mojito), ad emotions (e.g., fun), and advertisement data, which may be output from the NLP tools 712. The brand (e.g., BACARDI) may originate from any source, such as a whitelist, user profile, ad data, etc. The brand/ad term may be provided or inferred from different sources. A second updated prompt 720-2 may further be based on user preferences 714 indicating the user 702 likes spices and BACARDI rum.

In the example of FIG. 7, the user generated prompt 710 “how do I make a mojito” undergoes natural language processing by the NLP tools 712. The NLP tools 712 may include named entity recognition generating “mojito,” emotion analysis generating “fun,” sentiment classification generating “positive” and activity detection generating “planning.” Other NLP tools 712 are also contemplated, as the NLP tools 712 shown in FIG. 7 are non-limiting. The NLP tools 712 may also consider sensor data and context when generating the NLP tools output.

The brand preferences 716 receive the output from the NLP tools 712 and generate the brand BACARDI, and rum recipes with BACARDI. The user preferences 714 also receive the output from the NLP tools 712. The user preferences 714 may include a user profile, blacklist, and whitelist. In the example of FIG. 7, the user preferences 714 indicate the user 702 enjoys spice and is an alcohol consumer.

The (multimodal) foundation models and/or small models and their low rank adapter versions 718 include visual or cross-lingual language models (XLMs) and a quantity of at least two (e.g., n+1) of low rank adapters (XLM-LoRA-1 to XLM-LoRA-n). Although low rank adapters are specified, any technique for adapting the model to new context may be employed. In the example of FIG. 7, the low rank adapters 718 correspond to food and beverage, retail, entertainment, education, electronics, and travel, although the adapters are not limited to these specific examples, as other product categories may be used. Based on the input from the NLP tools 712, brand preferences 716 and the user preferences 714, the low rank adapter 718 corresponding to food and beverage is selected. The updated prompts 720 are generated based on this selection.

The updated prompts 720 may be fed to a generative AI-XLM system 704, which generates output 722 for the user 702. The output 722 based on the updated prompts 720 is: “For a classic great tasting mojito you need Bacardi white rum, lime juice, soda water, mint, . . . ” and/or “For a spicy mojito you need Bacardi spiced rum & ginger.”

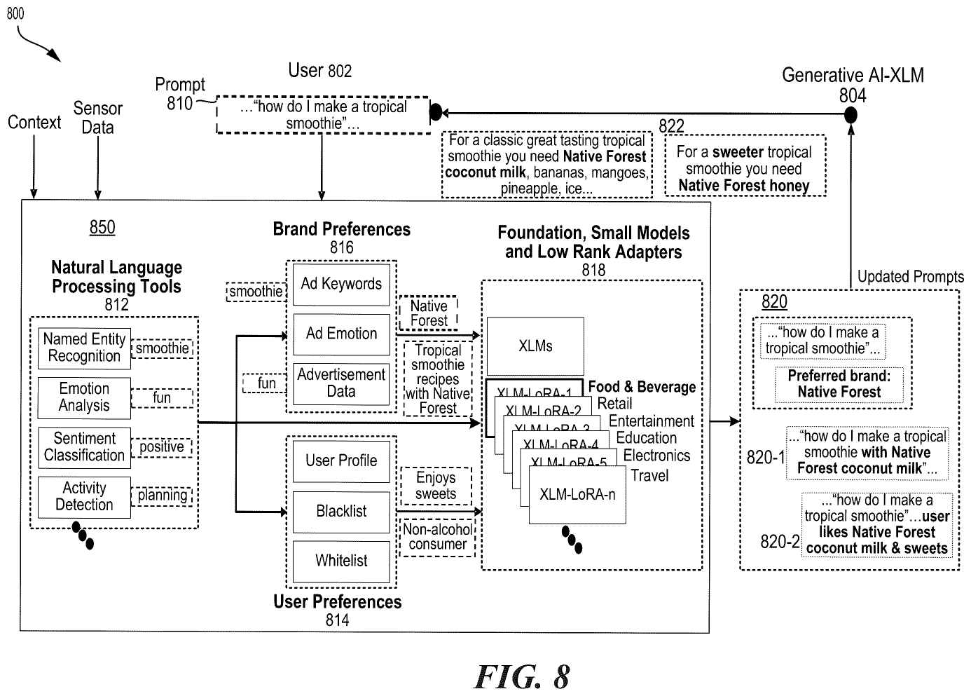

FIG. 8 is a block diagram illustrating an example 800 of text-based advertisement placement, in accordance with various aspects of the present disclosure. In the example 800 of FIG. 8, an ad module 850 may modify (or update) a prompt 810 from a user 802, and/or supplement the prompt 810 with preferred brands using natural language processing (NLP) tools 812, user preferences 814, brand (e.g., advertiser) preferences 816, and (multimodal) foundation models and/or small models and their low rank adapter versions 818. Updated prompts 820 include ad placements. For example, a first updated prompt 820-1 may be based on a brand preference 816 of NATIVE FOREST coconut milk and the original prompt 810. The brand preferences 816 may include ad keywords (e.g., smoothie), ad emotions (e.g., fun), and advertisement data, which may be output from the NLP tools 812. A second updated prompt 820-2 may further be based on user preferences 814 indicating the user 802 likes sweets and is not an alcohol consumer.

In the example of FIG. 8, the user generated prompt 810 “how do I make a tropical smoothie” undergoes natural language processing by the NLP tools 812. The NLP tools 812 may include named entity recognition generating “smoothie,” emotion analysis generating “fun,” sentiment classification generating “positive” and activity detection generating “planning.” Other NLP tools 812 are also contemplated, as the NLP tools 812 shown in FIG. 8 are non-limiting. The NLP tools 812 may also consider sensor data and context when generating the NLP tools output.

The brand preferences 816 receive the output from the NLP tools 812 and generate the brand NATIVE FOREST, and tropical smoothie recipes with NATIVE FOREST. The user preferences 814 also receive the output from the NLP tools 812. The user preferences 814 may include a user profile, blacklist, and whitelist. In the example of FIG. 8, the user preferences 814 indicate the user 802 enjoys sweets and is not an alcohol consumer.

The (multimodal) foundation models and/or small models and their low rank adapter versions 818 include visual or cross-lingual language models (XLMs) and a quantity (n+1) of low rank adapters (XLM-LoRA-1 to XLM-LoRA-n). In the example of FIG. 8, the low rank adapters 818 correspond to food and beverage, retail, entertainment, education, electronics, and travel, although the adapters are not limited to these specific examples. Based on the input from the NLP tools 812, brand preferences 816 and the user preferences 814, the low rank adapter 818 corresponding to food and beverage is selected. The updated prompts 820 are generated based on this selection.

The updated prompts 820 may be fed to a generative AI-XLM system 804, which generates output 822 for the user 802. Based on the updated prompts 820, the output 822 is: “For a classic great tasting tropical smoothie you need Native Forest coconut milk, bananas, mangoes, pineapple, ice, . . . ” and/or “For a sweeter tropical smoothie you need Native Forest honey.”

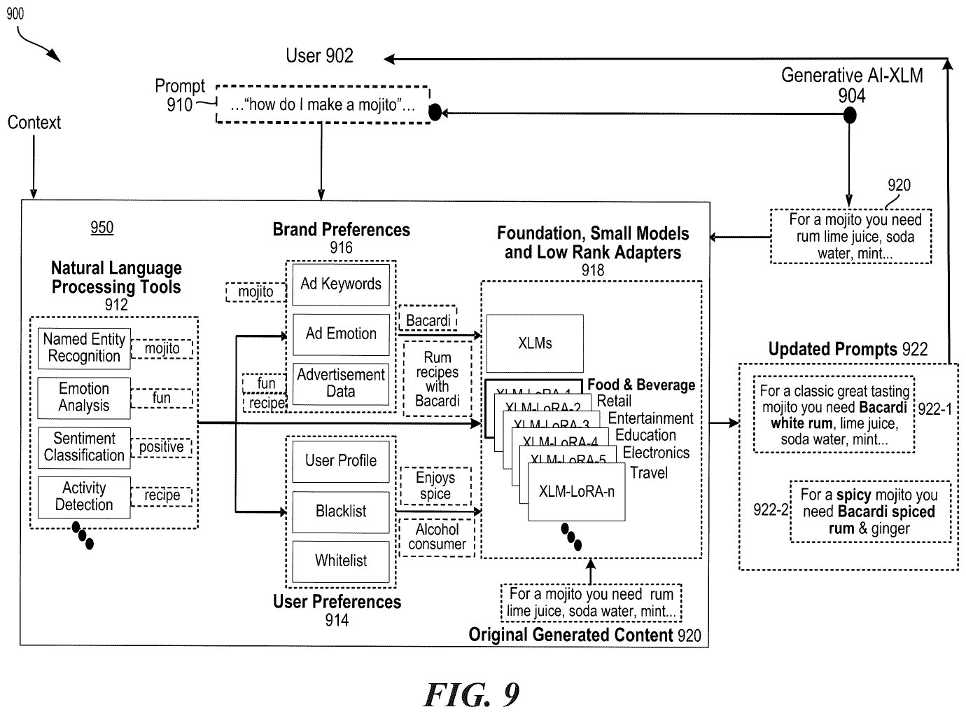

FIG. 9 is a block diagram illustrating an example 900 of text-based advertisement placement, in accordance with various aspects of the present disclosure. In the example 900 of FIG. 9, an ad module 950 may modify (or update) an original generated response 920 generated by a generative AI-XLM system 904, instead of modifying a prompt 910 from a user 902. The ad module 950 modifies the original generated response 920 with preferred brands using natural language processing (NLP) tools 912, user preferences 914, brand (e.g., advertiser) preferences 916, and (multimodal) foundation models and/or small models and their low rank adapter versions 918. Updated responses 922 include ad placements. For example, a first updated response 922-1 may be based on a brand preference 916 of BACARDI and the original prompt 910. The brand preferences 916 may include ad keywords (e.g., mojito), ad emotions, and advertisement data (e.g., fun, recipe), which may be output from the NLP tools 912. A second updated response 922-2 may further be based on user preferences 914 indicating the user likes spices and is an alcohol consumer. As noted previously, the source of what is presented to the user may come from a variety of sources. Information, such as brand names, user preferences, emotions, related words, etc. can drive what is presented to whom and when the information is presented.

In the example of FIG. 9, the user generated prompt 910 “how do I make a mojito” undergoes natural language processing by the NLP tools 912. The NLP tools 912 may include named entity recognition generating “mojito,” emotion analysis generating “fun,” sentiment classification generating “positive” and activity detection generating “recipe.” Other NLP tools 912 are also contemplated, as the NLP tools 912 shown in FIG. 9 are non-limiting examples. The NLP tools 912 may also consider context when generating the NLP tools output.

The brand preferences 916 receive the output from the NLP tools 912 and generate the brand BACARDI, and rum recipes with BACARDI. The user preferences 914 also receive the output from the NLP tools 912. The user preferences 914 may include a user profile, blacklist, and whitelist. In the example of FIG. 9, the user preferences 914 indicate the user 902 enjoys spice and is an alcohol consumer.

The (multimodal) foundation models and/or small models and their low rank adapter versions 918 include visual or cross-lingual language models (XLMs) and a quantity (n+1) of low rank adapters (XLM-LoRA-1 to XLM-LoRA-n). In the example of FIG. 9, the low rank adapters 918 correspond to food and beverage, retail, entertainment, education, electronics, and travel, although the adapters are not limited to these specific examples. Based on the input from the NLP tools 912, brand preferences 916, and the user preferences 914, the low rank adapter 918 corresponding to food and beverage is selected. The updated response 922 with ads is generated based on this selection. The updated response 922 with ads is also generated based the original generated response 920 from the generative AI-XLM system 904, which is based on the original prompt 910. The updated response 922 is returned to/output to the user 902.

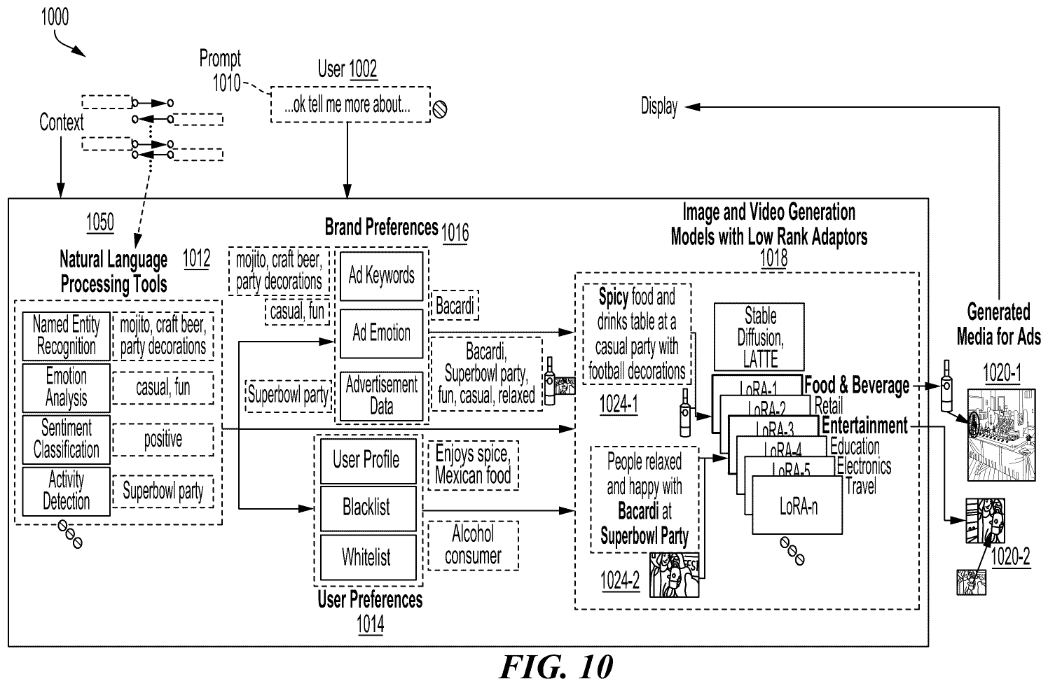

FIG. 10 is a block diagram illustrating an example 1000 of banner advertisement placement using context, in accordance with various aspects of the present disclosure. In the example 1000 of FIG. 10, an ad module 1050 may generate banner ads 1020-1, 1020-2 while a user 1002 is generating a prompt 1010. The banner ads 1020-1, 1020-2 may be generated by the ad module 1050 based on conversation context (e.g., the interaction between the user 502 and generative AI system 504 of FIG. 5) to extract relevant brands for advertisements, combined with user preferences 1014 and brand preferences 1016 (e.g., brand provided data, such as text, images, videos) to guide generation of images, GIFs, videos, etc., in the banner ads 1020-1, 1020-2. For example, at 1020-2 a stock image may be updated to show the Superbowl. The media may be generated using diffusion-based models, as an example, that make use of context, brand data such as images, emotions, sentiment, activities, etc., as well as user preferences 1014. The generated media can be used as banner ads 1020-1, 1020-2 while the user continues constructing the prompt 1010, and later waiting for generated content based on the prompt 1010.

Natural language processing (NLP) tools 1012, user preferences 1014, brand (e.g., advertiser) preferences 1016, and image and video generation models with low rank adapters 1018 can operate together to create the banner ads 1020-1, 1020-2 including ad placements. For example, a first banner ad 1020-1 may be based on a brand preference 1016 of BACARDI and the context. The brand preferences 1016 may include ad keywords (e.g., mojito, craft beer, party decorations), ad emotions (e.g., casual, fun), and advertisement data (e.g., Superbowl party), which may be output from the NLP tools 1012. A second banner ad 1020-2 may display a stock image updated to show the Superbowl.

In the example of FIG. 10, the user generated prompt 1010 “ . . . ok, tell me more about . . . ” and the context undergo natural language processing by the NLP tools 1012. The NLP tools 1012 may include named entity recognition generating keywords, such as “mojito, craft beer, party decorations,” emotion analysis generating “casual fun,” sentiment classification generating “positive,” and activity detection generating “Superbowl party.” Other NLP tools 1012 are also contemplated, as the NLP tools 1012 shown in FIG. 10 are non-limiting.

The brand preferences 1016 receive the output from the NLP tools 1012 and generate the brand BACARDI, and other keywords, such as Superbowl party, fun, casual, relaxed. The user preferences 1014 also receive the output from the NLP tools 1012. The user preferences 1014 may include a user profile, blacklist, and whitelist. In the example of FIG. 10, the user preferences 1014 indicate the user 1002 enjoys spicy Mexican food, and is an alcohol consumer.

The image and video generation models with low rank adapters 1018 include models, such as STABLE DIFFUSION or LATTE and a quantity (n+1) of low rank adapters (LoRA-1 to LoRA-n). In the example of FIG. 10, the low rank adapters 1018 correspond to food and beverage, retail, entertainment, education, electronics, and travel, although the adapters are not limited to these specific examples. Based on the input from the NLP tools 1012, brand preferences 1016, and the user preferences 1014, the low rank adapter 1018 corresponding to food and beverage, and/or the low rank adapter 1018 corresponding to entertainment are selected. The generated media for the banner ads 1020-1 and/or 1020-2 are generated based on the low rank adapter selections, respectively, and also content 1024-1, 1024-2 generated by the image and video generation models that is input to the selected low rank adapters 1018.

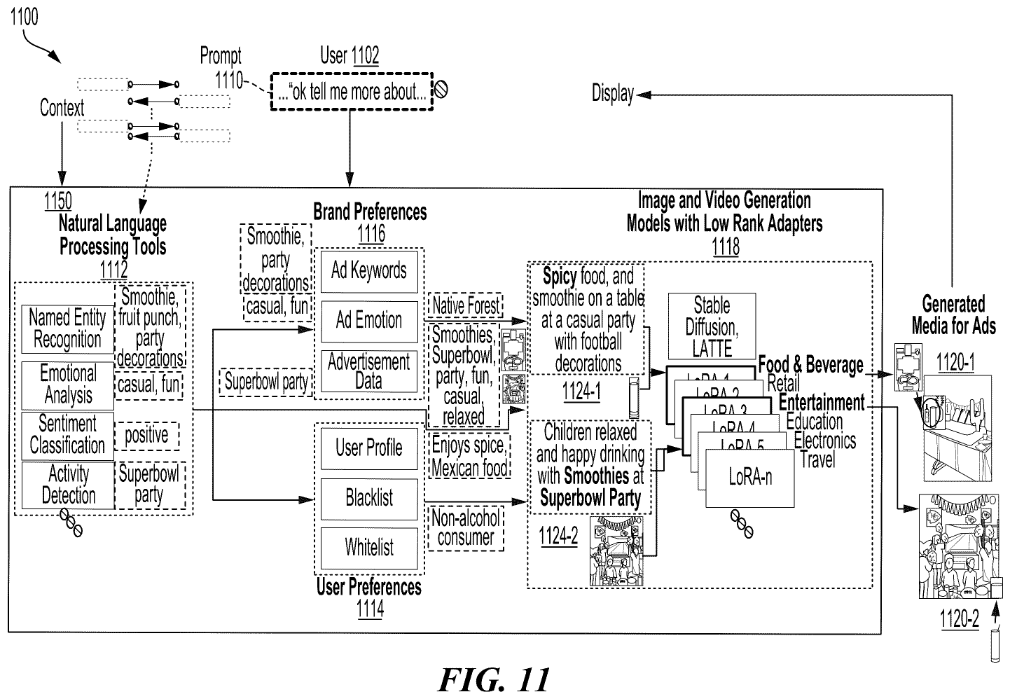

FIG. 11 is a block diagram illustrating an example 1100 of banner advertisement placement using context, in accordance with various aspects of the present disclosure. In the example 1100 of FIG. 11, an ad module 1150 may generate banner ads 1120-1, 1120-2 while a user 1102 is generating a prompt 1110. The banner ads 1120-1, 1120-2 may be generated by the ad module 1150 based on conversation context (e.g., the interaction between the user 602 and generative AI system 604 of FIG. 6) to extract relevant brands for advertisements, combined with user preferences 1114 and brand preferences 1116 (e.g., brand provided data, such as text, images, videos) to guide generation of images, GIFs, videos, etc., in the banner ads 1120-1, 1120-2. The media may be generated using diffusion-based models, for example, that make use of context, brand data such as images, emotions, sentiment, activities, etc., as well as user preferences 1114. The generated media can be used as banner ads 1120-1, 1120-2 while the user continues constructing the prompt 1110, and later waiting for generated content based on the prompt 1110.

Natural language processing (NLP) tools 1112, user preferences 1114, brand (e.g., advertiser) preferences 1116, and image and video generation models with low rank adapters 1118. The banner ads 1120-1, 1120-2 include ad placements. For example, a first banner ad 1120-1 may be based on a brand preference 1116 of NATIVE FOREST and the context. The brand preferences 1116 may include ad keywords (e.g., smoothie, party decorations), ad emotions (e.g., casual, fun), and advertisement data (e.g., Superbowl party), which may be output from the NLP tools 1112. A second banner ad 1120-2 may show a stock image updated to show a smoothie.

In the example of FIG. 11, the user generated prompt 1110 “ok, tell me more about . . . ” and the context undergo natural language processing by the NLP tools 1112. The NLP tools 1112 may include named entity recognition generating keywords, such as “smoothie, fruit punch, party decorations,” emotion analysis generating “casual fun,” sentiment classification generating “positive” and activity detection generating “Superbowl party.” Other NLP tools 1112 are also contemplated, as the NLP tools 1112 shown in FIG. 11 are non-limiting examples.

The brand preferences 1116 receive the output from the NLP tools 1112 and generate the brand NATIVE FOREST, and other keywords, such as smoothies, Superbowl party, fun, casual, relaxed. The user preferences 1114 also receive the output from the NLP tools 1112. The user preferences 1114 may include a user profile, blacklist, and whitelist. In the example of FIG. 11, the user preferences 1114 indicate the user 1102 enjoys spicy Mexican food, and is not an alcohol consumer.

The image and video generation models with low rank adapters 1118 include models, such as STABLE DIFFUSION or LATTE and a quantity (n+1) of low rank adapters (LoRA-1 to LoRA-n). In the example of FIG. 11, the low rank adapters 1118 correspond to food and beverage, retail, entertainment, education, electronics, and travel, although the adapters are not limited to these specific examples. Based on the input from the NLP tools 1112, brand preferences 1116, and the user preferences 1114, the low rank adapter 1118 corresponding to food and beverage is selected, and/or the low rank adapter 1118 corresponding to entertainments is selected. The generated media for banner ads 1120-1 and/or 1120-2 are generated, respectively, based on the low rank adapter selections and also content 1124-1, 1124-2 generated by the image and video generation models and input to the respective low rank adapters. For example, at 1120-1 a stock image of a NATIVE FOREST beverage may be inserted into the ad.

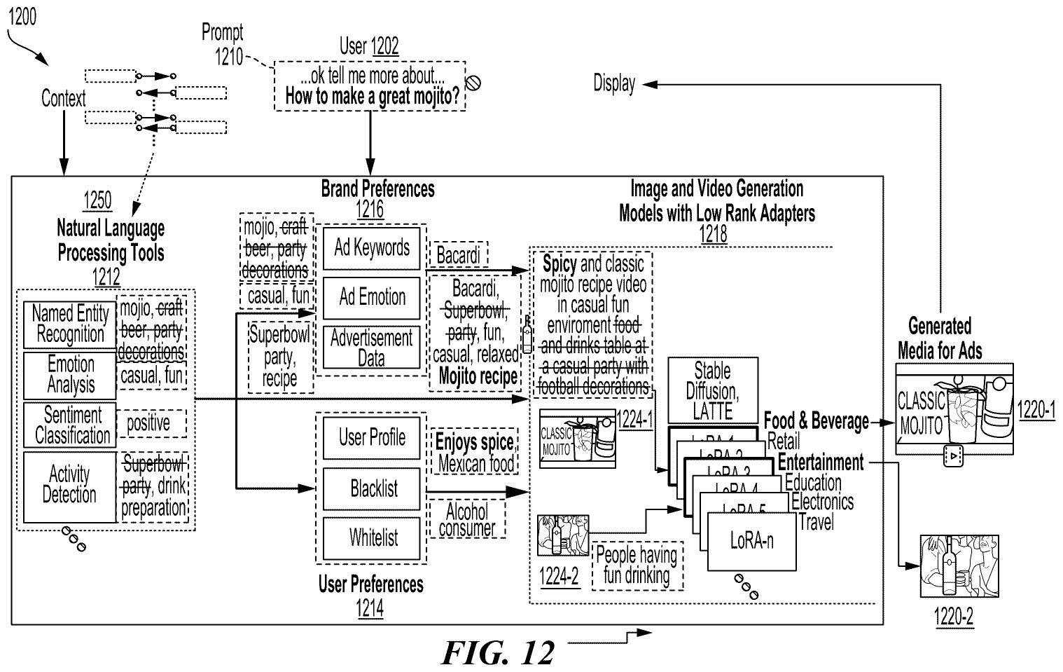

FIG. 12 is a block diagram illustrating an example 1200 of banner advertisement placement using context, in accordance with various aspects of the present disclosure. In the example 1200 of FIG. 12, an ad module 1250 may generate banner ads 1220-1, 1220-2 while a user 1202 is generating a prompt 1210. The banner ads 1220-1, 1220-2 may be generated by the ad module 1250 based on conversation context (e.g., the interaction between the user 502 and generative AI system 504 of FIG. 5) to extract relevant brands for advertisements, combined with user preferences 1214 and brand preferences 1216 (e.g., brand provided data, such as text, images, videos) to guide generation of images, GIFs, videos, etc., in the banner ads 1220-1, 1220-2. The banner ads 1220-1, 1220-2 are also generated based on a user prompt 1210, which provides additional information to narrow down results based on the context alone. In the example of FIG. 12, the user generated prompt 1210 is “ok, tell me more about How to make a great mojito?”

Natural language processing (NLP) tools 1212, user preferences 1214, brand (e.g., advertiser) preferences 1216, and image and video generation models with low rank adapters 1218 can operate together to create banner ads 1220-1, 1220-2 that include ad placements. For example, a first banner ad 1220-1 may be a video based on a brand preference 1216 of BACARDI, the user generated prompt 1210, and the context. A second banner ad 1220-2 may show a stock image updated to show a bottle of BACARDI rum or a new image generated with AI to include a bottle of BACARDI rum.

The NLP tools 1212 may include named entity recognition generating keywords, such as “mojito,” with craft beer and party decorations excluded based on the user generated prompt 1210. Emotion analysis may generate “casual fun,” sentiment classification may generate “positive” and activity detection may generate “drink preparation” while excluding “Superbowl party” based on the prompt 1210 not including “Superbowl party.” Other NLP tools 1212 are also contemplated, as the NLP tools 1212 shown in FIG. 12 are non-limiting.

The brand preferences 1216 receive the output from the NLP tools 1212 and generate the brand BACARDI, and other keywords, such as fun, casual, relaxed, and mojito recited with Superbowl party excluded. The user preferences 1214 also receive the output from the NLP tools 1212. The user preferences 1214 may include a user profile, blacklist, and whitelist. In the example of FIG. 12, the user preferences 1214 indicate the user 1202 enjoys spicy Mexican food, and is an alcohol consumer.

The image and video generation models with low rank adapters 1218 include models, such as STABLE DIFFUSION or LATTE and a quantity (n+1) of low rank adapters (LoRA-1 to LoRA-n). In the example of FIG. 12, the low rank adapters 1218 correspond to food and beverage, retail, entertainment, education, electronics, and travel, although the adapters are not limited to these specific examples. Based on the input from the NLP tools 1212, brand preferences 1216, and the user preferences 1214, the low rank adapter 1218 corresponding to food and beverage is selected, and/or the low rank adapter 1218 corresponding to entertainment is selected. The generated media for the banner ads 1220-1 and/or 1220-2 are generated, respectively, based on the low rank adapter selections and also content 1224-1, 1224-2 generated by the image and video generation models and input to the respective low rank adapters. The first piece of content 1222-1 excludes “drink table at a casual party with football decorations,” based on the prompt 1210.

In some aspects, the ad model (e.g., the first LLM, the second LLM, the foundation models, small models, LoRAs, the natural language processing tools, the XLMs, etc.) may be weighted based on advertiser payments. For example, one advertiser may opt (e.g., via payment) to have one of its brands weighted higher than normal in a given distribution of probabilities for each next word of a response. In other aspects, a payment system is provided such that payment is received based on a tracked frequency or quantity of ads presented for a particular brand. Alternatively, the advertiser may pay to use different parameters during inference. For example, if the probability for the brand being selected for an ad is greater than a threshold, for example, 0.45, which has a highest chance of being selected, then lowering a temperature parameter may increase the probability for being selected. In other words, lowering the temperature parameter may make the response more deterministic. Thus, an entity may be interested in lowering a temperature parameter for certain responses. Less popular brands with lower selection probabilities may prefer to pay to increase temperature parameters so that the distribution of less likely words becomes more uniform. Thus, the model (and/or any of its weights, parameters, hyperparameters, etc.) may be manipulated to select a relevant response.

For example, parameters that may be adjusted to control word selection may include (but are not limited to) temperature, Top P (e.g., highest probability), and penalties. Example penalties include, but are not limited to, a frequency penalty and a presence penalty. For example, using the same ad word/phrase too often or using too many ad words/phrases in a given response (or in the overall experience) may be penalized. For example, repeatedly saying “brand X rum” every time the word rum is mentioned in the recipe may sound unnatural. Using more than one or x number of ad word/phrases may be penalized (e.g., to avoid/minimize usage of something like “A mojito is made with brand X rum, mint, [brand Y] sugar, [brand Z] simple syrup, . . . ”) as that may turn off some users or otherwise hurt the user experience. Thus, in some aspects, opportunities to otherwise present/match an ad may be reduced due to a presence of one or more other ads.

If ads are permitted, the ads may be presented with a light touch. For example, a frequency of a particular word(s) may be limited to only x number; or only y total ads may be allowed, for example, different brands per response or density (number of ads per amount of text).

As noted above, the present disclosure is not limited to LLMs or text generation. In some aspects, an image is generated by the AI/ML model with a product placement. For example, the prompt “a photorealistic image of a person drinking a soda” may cause the AI/ML model to return an image of the person drinking a can of COCA-COLA. In another example, the AI/ML model may return an image of someone drinking a soda (e.g., COKE or another brand) but also include a branded pizza box sitting on a table in the generated image. That is, an opportunity is available to inject an advertiser brand that is related to the image/prompt in addition to or instead of a “COKE” brand ad being generated in the image. For example, a response can say “branded pizza box X pairs well with COKE.”

Examples of brand personalization will now be discussed, assuming context where a user is planning a vacation. In these examples, a user profile indicates that the user likes {hiking, relaxing on the beach, family fun activities like bowling, ice skating, going to movies, & sports events like ice hockey, football}. The generative AI system creates ads for hiking, showing a family enjoying a hike. Ad personalization may be applied to the clothes, apparel, and drinks, with the personalization based on the context (early-fall New England vacation), users' preferences (styles, colors), and brands (outdoor apparel and wear, sport drinks). For even more specific personalization, a user's pet dog may be added to the image.

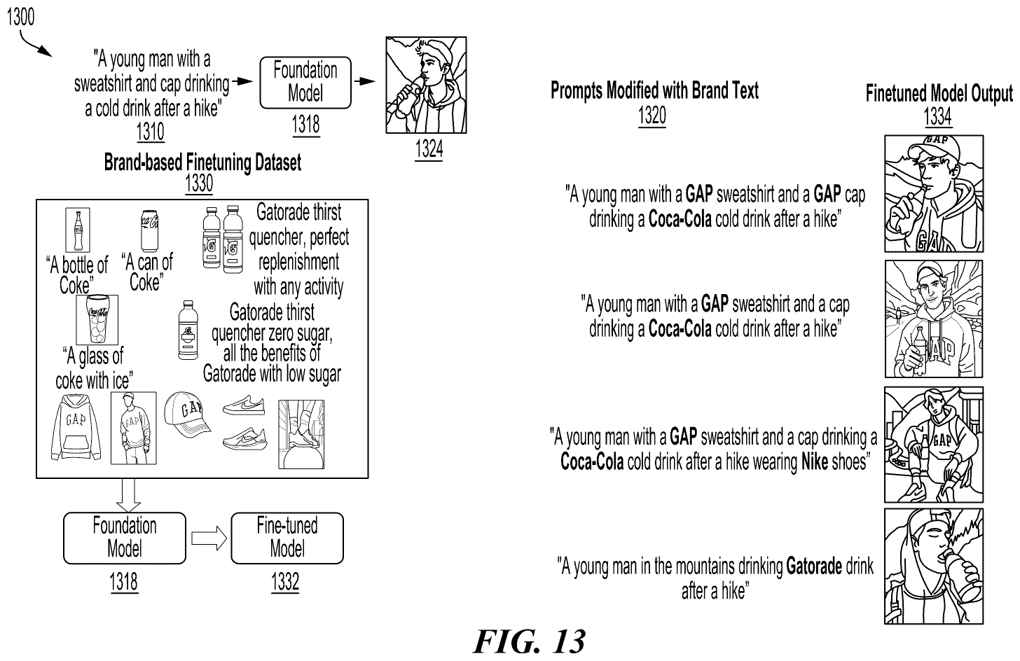

FIG. 13 is a block diagram illustrating an example 1300 of content generation model fine tuning using advertising provided datasets, in accordance with various aspects of the present disclosure. In the example 1300 of FIG. 13, an initial prompt 1310, “A young man with a sweatshirt and cap drinking a cold drink after a hike,” is received at a foundation model 1318 and generates an image 1324. The foundation model 1318 may receive a brand-based finetuning data set 1330, and accordingly, a fine-tuned model 1332 is created. Using the fine-tuned model 1332, the prompt 1310 may be modified with brand text to obtain potential modified prompts 1320: “A young man with a GAP sweatshirt and GAP cap drinking a Coca-Cola cold drink after a hike,” “A young man with a GAP sweatshirt and a cap drinking a Coca-Cola cold drink after a hike,” “A young man with a GAP sweatshirt and a cap drinking a Coca-Cola cold drink after a hike wearing Nike shoes,” or “A young man in the mountains drinking Gatorade drink after a hike.” Corresponding fine-tuned model output 1334 is seen in FIG. 13.

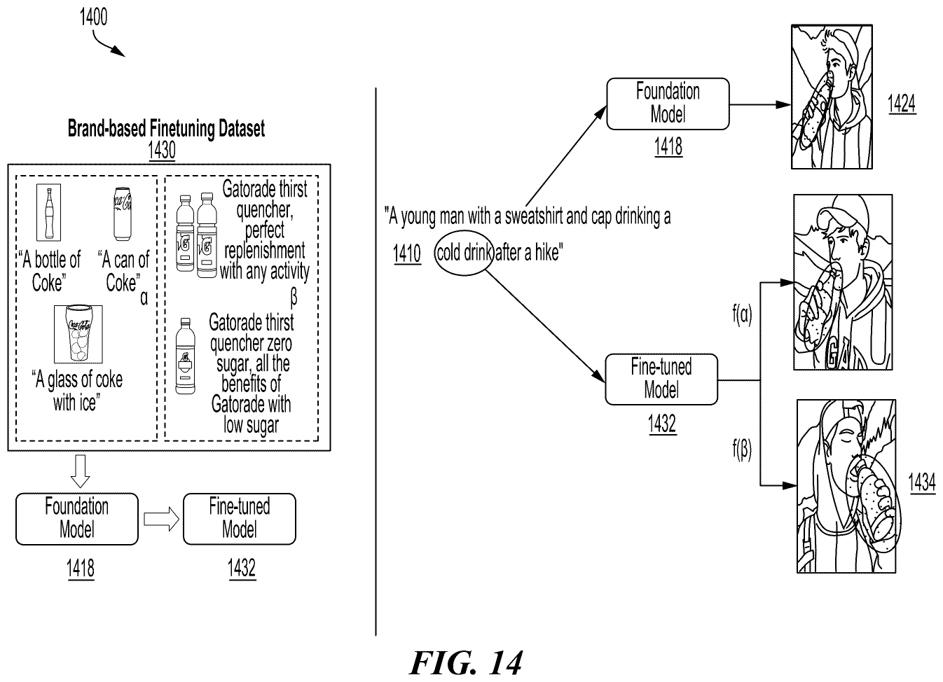

FIG. 14 is a block diagram illustrating an example 1400 of content generation model fine tuning using advertising provided datasets, in accordance with various aspects of the present disclosure. In the example 1400 of FIG. 14, the probability of generated content 1424 having brand data can be controlled in a probabilistic fashion by the weighting of brand data in a brand finetuning dataset 1430. For example, f(α) and f(β) correspond to weighting functions for different brands “COKE” and “GATORADE,” respectively. The original prompt 1410 is: “A young man with a sweatshirt and cap drinking a cold drink after a hike.” In this example, the “cold drink” image 1434 is generated with a particular brand in the fine-tuned model 1432, with the probability being a function (f(α) or f(β)) of the brand-based finetuning dataset 1430 and a sampling frequency of this dataset. Instead of finetuning a foundation model 1418 directly (as shown in FIG. 14), a low rank adapter can be trained to achieve similar results.

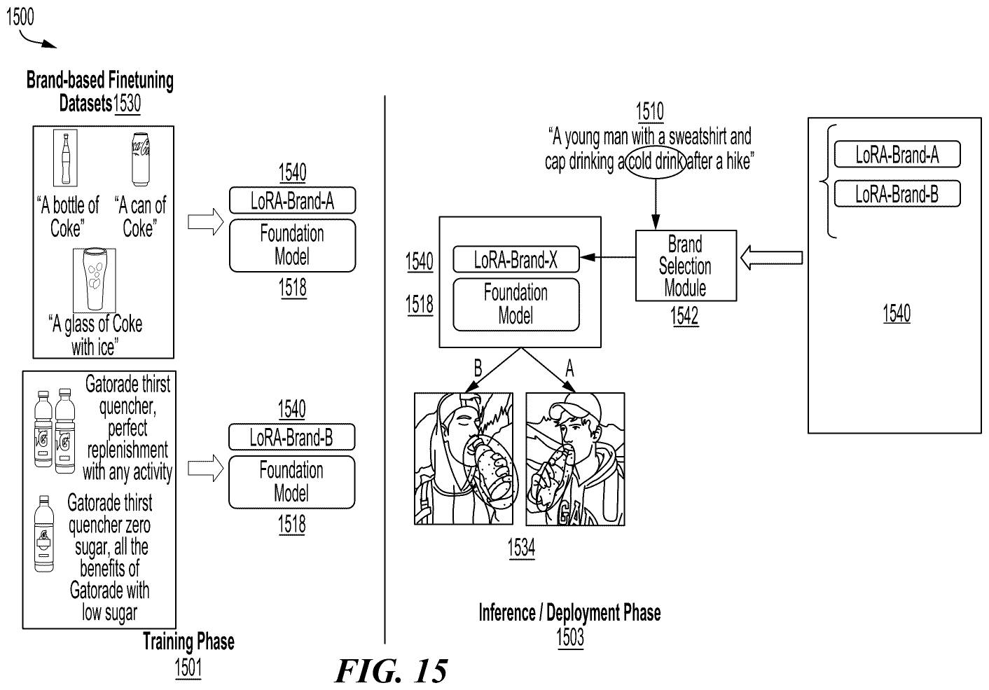

FIG. 15 is a block diagram illustrating an example 1500 of low rank adapter content generation using advertising provided datasets, in accordance with various aspects of the present disclosure. In the example 1500 of FIG. 15, the original prompt 1510 is: “A young man with a sweatshirt and cap drinking a cold drink after a hike.” The probability of generated content 1534 having the brand data can be controlled in a probabilistic fashion by choosing a LoRA brand adapter 1540. In this example, the brand adapter 1540 relevant for “cold drink” is selected with some probability and either brand A or brand B content is generated using the adapter 1540 and a foundation model 1518. A brand selection module 1542 selects which brand content is selected. During a training phase 1501, the brand based finetuning data sets 1530 are used to train the adapters 1540 and the foundation models 1518. During an inference/deployment stage 1503, the adapter 1540 is selected by the brand selection module 1542. For example, the brand selection module may select brand A 60% of the time and brand B 40% of the time. The selected adapter 1540 and the foundation model 1518 then process the prompt 1510 to output content 1534 including either brand A content or brand B content.

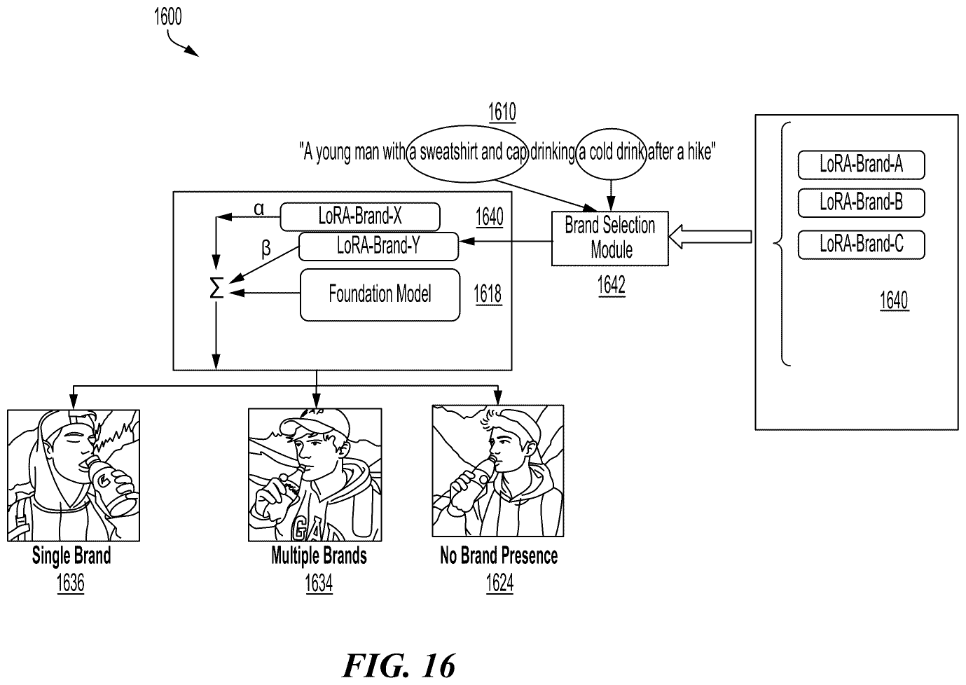

FIG. 16 is a block diagram illustrating an example 1600 of low rank adapter content generation using advertising provided datasets, in accordance with various aspects of the present disclosure. In the example 1600 of FIG. 16, the original prompt 1610 is: “A young man with a sweatshirt and cap drinking a cold drink after a hike.” In the prompt 1610 multiple potential brands are detected: “cold drink” and “sweatshirt and cap.” To display content for multiple brands, multiple LoRa brand adapters 1640 can be deployed concurrently. An output from the LoRA brand adapters 1640 for different brands can be weighted with respect to an output 1624 with no brand presence from a foundation model 1618 to generate content 1634 with the presence of multiple brands or content 1636 with the presence of a single brand. A brand selection module 1642 may perform the weighting between brands.

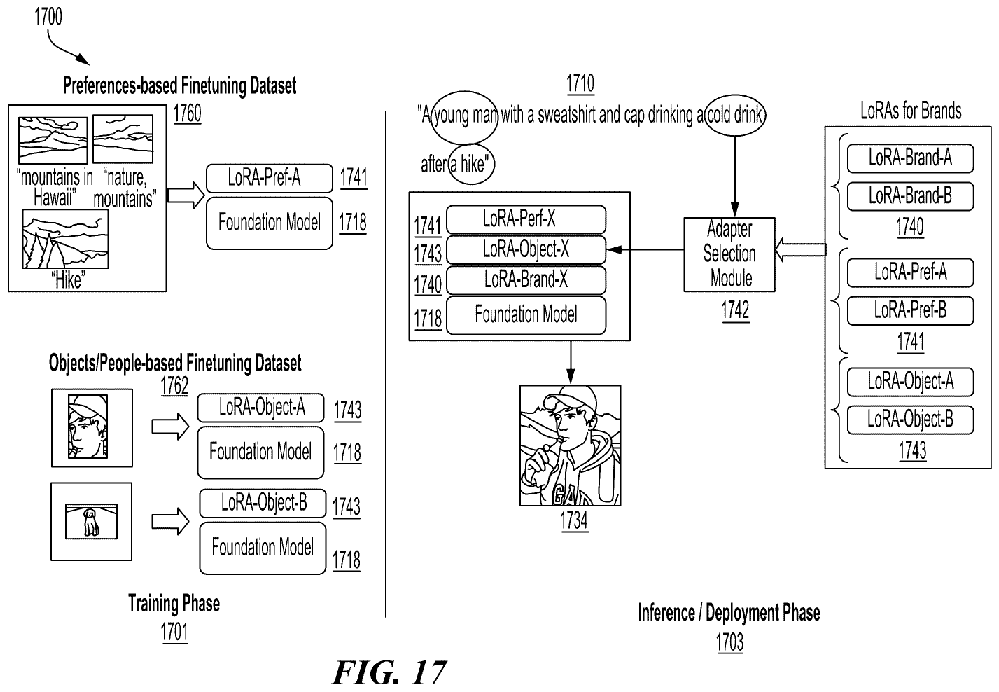

FIG. 17 is a block diagram illustrating an example 1700 of personalization of low rank adapter content, in accordance with various aspects of the present disclosure. In the example 1700 of FIG. 17, the original prompt 1710 is: “A young man with a sweatshirt and cap drinking a cold drink after a hike.” The terms “a young man” and “hike” may trigger personalization. Thus, the brand adapters 1740 can be mixed with personalized adapters 1741, 1743 for user's preferences for style, and locations as well as people and objects to make ads very specific. For example, adapters may be available for people, or their pets, enabling fine tuning based on family photos or a particular celebrity that the person may adore. The output from these adapters 1740, 1741, 1743 can be weighted with respect to each other and the foundation model 1718 to modulate a level of personalization and brand impact on generated content 1734. An adapter selection module 1742 may implement the weighting. The modulation can be based on advertisement spend, for example.

At a training phase 1701, a preference-based fine tuning data set 1760 trains the foundation model 1718 and preference-based low rank adapters 1741. In the example of FIG. 17, the user likes mountains. An objects/people-based fine tuning data set 1762 also trains the foundation model 1718 and object-based low rank adapters 1743, for example with pet photos and images of the user. During the inference/deployment phase 1703, the adapter selection module 1742 selects the appropriate low rank adapters 1740, 1741, 1743 to operate with the foundation model 1718 on the prompt 1710 to generate personalized output 1734.

In some aspects, an image may be generated with an advertisement, for example, by modifying the prompt. In other aspects, the image may be augmented, for example, via in-painting. In-painting or otherwise augmenting an existing image may be seen, for example, in a super zoom, according to some aspects. In a super zoom, an image (which may be a generated image or a real image) that has a small can or object may be modified such that the small can or object can be displayed as a can of COKE when the user zooms in on the object. The advertisement may not be visible prior to zooming in on the object, or may be out of focus or obscured prior to zoom or on smaller resolution devices (but visible on larger resolution devices in some aspects). For example, the text saying COKE may be so small as not to be visible on a mobile device, but if the image were displayed in a device with a larger resolution or screen size, then COKE could be visible without zooming in.

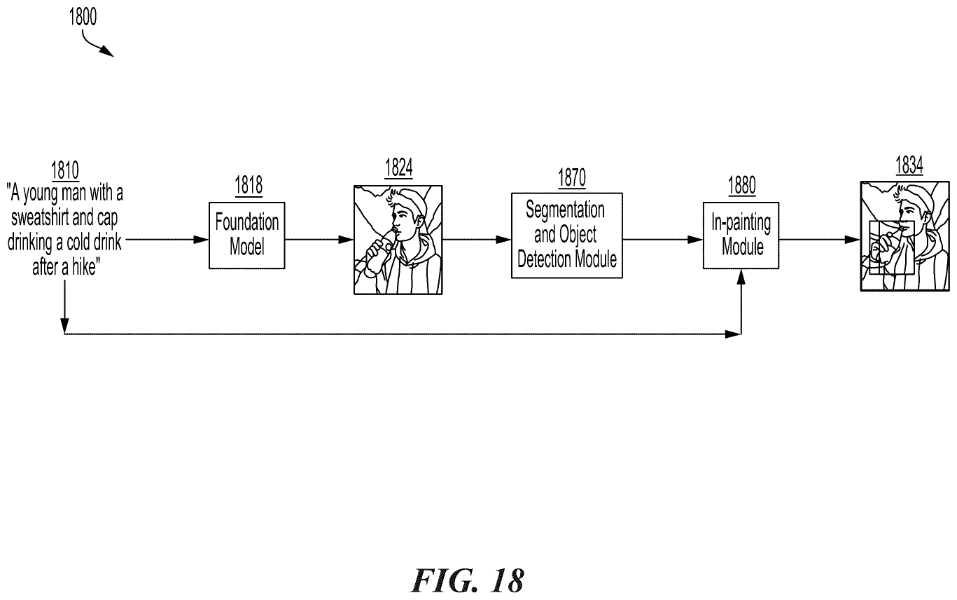

FIG. 18 is a block diagram illustrating an example 1800 of in-painting brand placement, in accordance with various aspects of the present disclosure. In the example 1800 of FIG. 18, the original prompt 1810 is: “A young man with a sweatshirt and cap drinking a cold drink after a hike.” An image 1824 generated by a foundation model 1818 can be modified after generation using an in-painting module 1880 that receives the text prompt 1810 as input, along with an output from a segmentation and object detection module 1870. The in-painting module 1880 replaces the object of interest detected by the segmentation and object detection module 1870 with a brand placement. This technique is an alternate solution for inserting a branded object into an image to obtain a branded image 1834, after the image 1824 has already been generated.

In various aspects of the present disclosure, text translations provide opportunities for advertising. For example: when translating a word or phrase from language A to language B, opportunities may exist for ad matching. In one example, “I like video games” translates to “Ich mag XBOX” instead of the generic “Ich mag Videospiele.”

According to aspects of the present disclosure, if multiple responses or drafts are requested (e.g., the user did not like the response), a new response can again be based on the same ad match as the original response. In other aspects, the ad match may be based on a new ad match, for example, a different product or other match opportunity, such as a name brand of a different item other than rum. In still further aspects, the new response may be free of any ad matching.

Examples will now be described for when a user is presented with multiple responses/drafts at once, for example, the AI/ML model generates four images (drafts) from which the user can select. In a first example, each response/draft may include the same advertisement match, for example, all four images include a can of the same soda brand. In a second example, some but not all responses/drafts may include the ad match. For example, two images may show a branded can of soda and two images may not have any brand shown on the can or may show no can whatsoever. In a third example, two images show a can with a first brand, one image shows a can with a second brand, and one image shows a can with no brand. In a third example, all four images show a branded can of soda, but one of the images also shows a branded pizza box. The other three images only show the branded soda can. In other words, some aspects may view the four generated responses/drafts as a single ad opportunity, for example, with the brand shown in each of the responses/drafts, or at least some of the images. In other aspects, the different responses/drafts are viewed as four different ad opportunities. For example, a different soda brand may be displayed in each response/draft. As noted above, other related brands, such as a pizza brand, could also be displayed in any of these opportunities.

Generally, the provided examples are for providing an ad in a situation involving a prompt and its corresponding response. In some aspects, an ad may be provided in subsequent responses in the same conversation or thread (also referred to as a single experience). In other aspects, the ad match opportunity occurs in future responses to unrelated prompts. Thus, for example, previous prompts and responses may be used as inputs for future ad matching.

In some aspects, injected ads (e.g., words, generated object, etc.) may be highlighted or otherwise include some indication that the words or object have been added, modified, or otherwise selected (e.g., as an advertisement). For example, bold, underline, double underline, a different font, a different color, a border, etc., may indicate an advertisement. In some aspects, a hyperlink, for example, to the product may be included in the output/response. A mouse hover may also be presented, such that additional information is provided when a cursor hovers over the injected item. As noted above, advertisements do not necessarily have to be injected as text. Ads can also be presented as images, or the like, within the AI/ML generated response. The highlighting/bolding (or other indication) allows the user to know that the ad is not part of the original fact pattern. In some implementations, the user may have the ability to toggle the bolding/highlighting on and off. In still other implementations, the user may have the ability to switch a displayed brand to another brand, in some instances with a user payment. In other implementations, the user may have the ability to remove or reduce the prominence of an ad, for example from a large, branded image to a smaller branded image, in some instances with user payment.

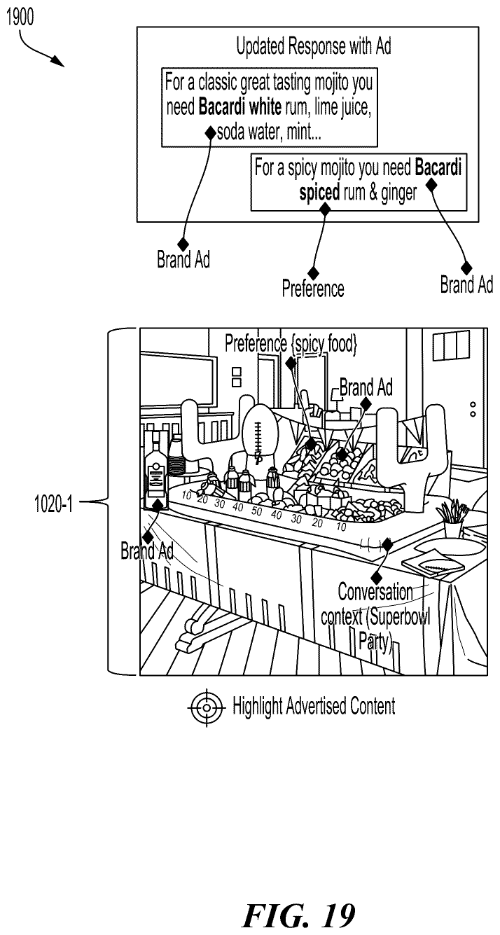

FIG. 19 is a block diagram illustrating an example 1900 of highlighted content attribution, in accordance with various aspects of the present disclosure. In the example 1900 of FIG. 19, banner ads 1020-1 are generated, for example, as described with respect to FIG. 10. The user can find the attribution for the added content in the generated banner ad 1020-1. Meta data may be sent by the generative AI system along with the created content and may be hidden or highlighted. Other means such as segmentation masks, or a textual description (e.g., what type of music was added) can also be used. In the example shown in FIG. 19, the brand ad “BACARDI” is indicated with a target symbol, as is the user preference, which is spicy food in this example. In some implementations (not shown), a hyperlink to the brand (e.g., BACARDI) is provided to enable the user to quickly access more information about and interact with the brand. In other implementations, some words are highlighted or bolded (or other change in appearance) in the prompts or the output banner ad 1020-1.

According to aspects of the present disclosure, regardless of whether an ad word(s) is emphasized or indicated as such, a flag or other metadata may exist to track usage of the ad-generated word/object. This tracking may distinguish an injected usage of the word versus using the word as normal (e.g., word(s) that would have been generated regardless of the ad match opportunity).

According to aspects of the present disclosure, a model provides follow-up responses or questions based on a match. These follow-ups provide opportunities for placing ad/matching. For example, in addition to providing the mojito recipe, the user may be further presented with: “Would you like to learn about other drinks using [brand X] rum?” “Would you like to learn more about the history of [brand X]?” This may also occur when a previous interaction was not matched. For example, a search for limes may result in a follow up question regarding mojitos recipes using lime and [brand X] rum.

In some aspects, an ad is injected in the text, for example, brand X rum as a recipe item. In other aspects, the recipe is presented and then there may be a final paragraph mentioning that brand X rum would be a good choice for the recipe that the AI/ML model provided. Thus, in some embodiments, a response to a prompt may include (at least) a first response portion and a second response portion. The first response portion may be similar to a response that would otherwise be presented without matching. The second response portion may be considered secondary information that may also include ad content.

In some aspects, ads may be paired or associated together. For example, when a certain beverage (such as [brand X] rum) is advertised, a certain snack that pairs well with that beverage may be advertised, or information related to tropical vacations may be served. In some aspects, the pairing or association is bidirectional, such that the generation of an ad for either will result in the generation of an ad or a follow-up for the other. In other aspects, the pairing or association is unidirectional, such that an ad for one will result in an ad or follow-up for the other, but the other item or brand will not result in an ad or follow-up for the initial item or brand.

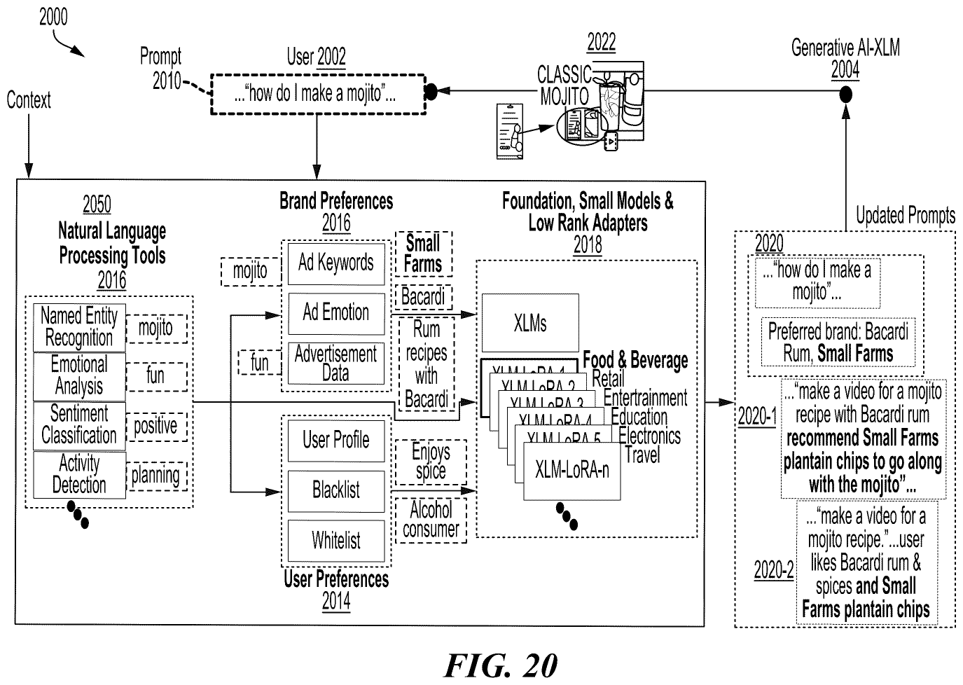

FIG. 20 is a block diagram illustrating paired ads, in accordance with various aspects of the present disclosure. An ad module 2050 may recommend product placement of other brands associated with the original brand (e.g., BACARDI) inside of generated media. In the example 2000 of FIG. 20, a brand of plantain chips is recommended for placement inside a video output 2022 showing a recipe for mojitos. The ad module 2050 may modify (or update) a prompt 2010 from a user 2002, and/or supplement the prompt 2010 with preferred brands using natural language processing (NLP) tools 2012, user preferences 2014, brand preferences 2016, and (multimodal) foundation models and/or small models and their low rank adapter versions 2018. The modified prompts 2020 includes ad placements for multiple brands. For example, a first modified prompt 2020-1 may be based on brand preferences 2016 of BACARDI and SMALL FARMS along with the original user generated prompt 2010. The brand preferences 2016 may receive ad keywords (e.g., mojito), ad emotions (e.g., fun), and advertisement data, which may be output from the NLP tools 2012. A second modified prompt 2020-2 may further be based on user preferences 2014 indicating the user 2002 likes spices and BACARDI rum.

In the example of FIG. 20, the user generated prompt 2010 “how do I make a mojito” undergoes natural language processing by the NLP tools 2012. The NLP tools 2012 may include named entity recognition generating keywords “mojito,” emotion analysis generating “fun,” sentiment classification generating “positive” and activity detection generating “planning.” Other NLP tools 2012 are also contemplated, as the NLP tools 2012 shown in FIG. 20 are non-limiting. The NLP tools 2012 may also consider context when generating the NLP tools output.

The brand preferences 2016 receive the output from the NLP tools 2012 and generate the brand BACARDI, rum recipes with BACARDI, and an associated brand “SMALL FARMS.” The user preferences 2014 also receive the output from the NLP tools 2012. The user preferences 2014 may include a user profile, blacklist, and whitelist. In the example of FIG. 20, the user preferences 2014 indicate the user 2002 enjoys spice and is an alcohol consumer.

The (multimodal) foundation models and/or small models and their low rank adapter versions 2018 include visual or cross-lingual language models (XLMs) and a quantity (n+1) of low rank adapters (XLM-LoRA-1 to XLM-LoRA-n). In the example of FIG. 20, the low rank adapters 2018 correspond to food and beverage, retail, entertainment, education, electronics, and travel, although the adapters are not limited to these specific examples. Based on the input from the NLP tools 2012, brand preferences 2016 and the user preferences 2014, the low rank adapter 2018 corresponding to food and beverage is selected. One or more of the updated prompts 2020 are generated based on this selection.

One or more of the updated prompts 2020 may be fed to a generative AI-XLM system 2004, which generates the video output 2022 for the user 2002. The video output 2022 is based on the updated prompts 2020: “ . . . make a video for a mojito recipe with Bacardi rum, recommend Small Farms Plantain chips to go along with the mojito . . . ” and/or “ . . . ‘make a video for a mojito recipe.’ . . . user likes Bacardi rum & spices and Small Farms plantain chips.”

Some articles, subject areas, etc., may be prevented from receiving ads or otherwise have their occurrence/frequency reduced. Such subject areas may relate to history, contentious topics, blacklisted topics/words, celebrities/athletes, etc. For instance, a non-ad-related response describing the events of Sep. 11, 2001, may use the names of the airlines involved. Whereas an ad-augmented response will not use those brand names or any other airline (or travel-related) words for injection due to the poor context for advertising. A more specific scenario is now described for when a brand may not want to be used with certain outputs (e.g., text, images, etc.). A soda brand X may provide specific contexts (e.g., soda brand X with any political person), scenarios, or other brands they do not want to be inserted into or inserted with. For example, soda brand X may prefer not to be displayed in a scene, such as a picnic with both soda brand X and soda brand Y products.

If ads are permitted, the ads may be presented with a light touch. For example, a frequency of a particular word(s) may be limited to only x number; or only y total ads may be allowed, for example, different brands per response or density (number of ads per amount of text). In other cases, only a certain or smaller number of ad words may be selected, etc. Words with multiple meanings may be checked to ensure the context is correct. For example, COKE may refer to the soda but also may be a nickname for the drug cocaine.

In some aspects, exceptions can be made. Although history may be a banned/limited topic, if the brand factually had a relation with the topic, then the brand may be considered. For example, if talking about a particular president who was known for particularly liking brand Z soda, then brand Z soda could potentially be mentioned.

According to further aspects of the present disclosure, displayed ads may receive feedback for reinforcement learning. For example, users may downvote an advertisement for being inappropriate to the context, irrelevant, awkward/unnatural usage, etc. Users performing some action based on the ad injection may be considered a strong indicator for (positive) feedback. Actions may include, for example, clicking on an ad hyperlink, using the word(s) in a subsequent prompt, or otherwise inquiring about the word/product. Leaving the page to go to a related page, for example, brandX.com is another action that may be considered user feedback. In various aspects, the received feedback can be used to adjust how future ads are provided. That is, the system may learn how and which brands are provided to the user and whether any brands are clicked on. For example, if “BACARDI” is clicked on by the user, the model notes that the user is interested in BACARDI. A feedback mechanism may thus modify the user preferences, such as the whitelist and blacklist, based on how the user reacts to ads. Ad matching techniques may be employed.

Similarly, advertisers may have opportunities to rate their ad placements. For example, the advertisers may receive lists or sets of every usage and optionally some or all context, such as the prompt, full response, subsequent prompts/answers, etc. Alternatively, the advertisers receive subsets/samples of usage.

Advertisers may be provided with a tool or other software, for example, a web portal or the like, for AI/ML model optimization. The advertisers may be able to train any model used. For example, in a single AI/ML model implementation, the advertiser may participate in updating the AI/ML model. If an ad selector model is employed, the advertiser may help train or fine-tune the ad selector model. The advertisers can create ad campaigns for such training.

The advertiser's tool may be configured to receive an input, for example, a brand name and a series of words/phrases, from an advertiser-user and populate a set of words, phrases, usage, etc., for training. This information may be input into the current ad AI/ML model, whether the model is a solo AI/ML model or an implementation with an ad dedicated AI/ML model. For example, by typing “brand X rum,” related words and/or phrases may appear, such as: rum, liquor, alcohol, mojito, cocktail, libation, mojito recipe, other rum drinks/recipes, how to make a mojito, best-tasting rum, finest rum, etc. Translations/variants in other languages/countries may also be provided. Optionally, other information, such as probabilities and/or weights, and relative rankings for each word/phrase may also be provided. As a result, the advertiser has an idea of what terms may already be associated with the brand. The tool can then add to, remove, or otherwise revise the set of words and/or phases. The other information may also be adjusted, such as with model training. For example, certain words and/or phrases may be manually added, removed, and revised, and/or parameters may be adjusted. In some aspects, certain words and/or phrases may be prevented from being associated with a brand.

In some aspects, training a model that selects advertisements may result in an inherently biased model. Thus, in some aspects to address the bias, a secondary AI/ML model (or a third AI/ML model) may generate additional keywords or example usages to feed the primary model, in order to adjust the model weights. For example, the use of mojito may be expanded into hundreds or thousands of samples. The expanded set may be generated using a particular large language model, obtained from a search engine, or obtained from another data source(s), etc. In some aspects, sentences and/or phrases in one or more languages can serve as a way to fine-tune the model.

For image generating models, such as diffusion models, advertisers may provide training data and training images. For example, pictures of their brand/products may be provided, such as images of cans of brand X soda, brand Y soda, etc., may be used for diffusion models or the like. The advertisers may control what images are shown. In other aspects, meta data, such as context information (e.g., location or settings), may be provided. The brand may be associated with this meta data or, alternatively, may be prevented from being associated from this metadata.

According to further aspects of the present disclosure, ad blockers may scrub responses of potential ad injections. For example, an ad blocker model residing on the user device may remove any brand names that appear in the received response. Alternatively, the ad blocker may regenerate the response in such a way that there is no brand name. For example, a response may be received as an input to the ad blocker model, which then outputs a similar response without any advertisements. The ad blocker may also randomly regenerate any response such that brands are randomly removed, changed, etc. In some aspects, users may request to have ads removed. In still other aspects, a free version of the generative AI system may include ads, whereas a paid version may not generate the ads, or may allow a user to change ads or a frequency of the ads appearing. For example, seven bottles of BACARDI may be presented in a free version, whereas the paid version may only insert a single bottle of BACARDI.

An example is now provided of how parameter manipulation may affect selection of probabilities of a given term (ad term). An example distribution is as follows: “A mojito is made with . . . ” results in the following probabilities: “rum”: 0.30; “mint”: 0.25; “sugar”: 0.20; “[brand X]”: 0.10; “[brand Y″]”: 0.08; “[brand Z]”: 0.06; other words: 0.01.

If the temperature parameter increases, for example, from one to two, the probabilities become more uniform (that is, the output becomes more random): “rum”: 0.30 decreases to 0.20; “mint”: 0.25 decreases to 0.18; “sugar”: 0.20 decreases to 0.17; “[brand X]”: 0.10 increases to 0.15; “[brand Y″]”: 0.08 increases to 0.14; “[brand Z]”: 0.06 increases to 0.11; and other words increases to 0.05.

If the temperature parameter decreases, for example, from one to 0.5, the probability differences become more pronounced. That is, “rum” increases from 0.30 to 0.65; “mint” decreases from 0.25 to 0.15; “sugar” decreases from 0.20 to 0.10; “[brand X]” decreases from 0.10 to 0.05; “[brand Y″]” decreases from 0.08 to 0.03; “[brand Z]” decreases from 0.06 to 0.02; and other words decreases from 0.01 to 0.001.

Another technique for parameter manipulation is now described. Top P is a function that determines how many words to sample. A higher Top P value considers more words than a lower Top P value. The Top P function includes the smallest set of words whose cumulative probability exceeds a threshold. Thus, if Top P is set to 0.85, only rum, mint, sugar, and [brand X] are considered for selection. If Top P is set to 0.9, then [brand Y] is also considered with the other four words. Thus, there may be incentive for brand Y to use a higher Top P, while brand X might prefer a lower Top P. According to aspects of the present disclosure, brands may manipulate the Top P value to benefit the brands.

It will be appreciated based on the above that advertisements or other matched or directed content may be generated or served at any time, for example, displayed or played (e.g., in text or audio form, or as a video or image) while a user types, while waiting for a response from a model, and/or in the result or response itself, or even thereafter in a follow up question or supplementary serving of an ad. Certain results may be favored or more heavily weighted, or content may explicitly be inserted into a result or output. Audio, imagery, text, certain colors, brands, name, etc., may all be forms of matched content. In some examples, the content is not an explicit reference to a brand, but rather representative of a specific brand or item. For example, an airline named “Oceans” may use ads that include waves and/or flying objects such as birds.

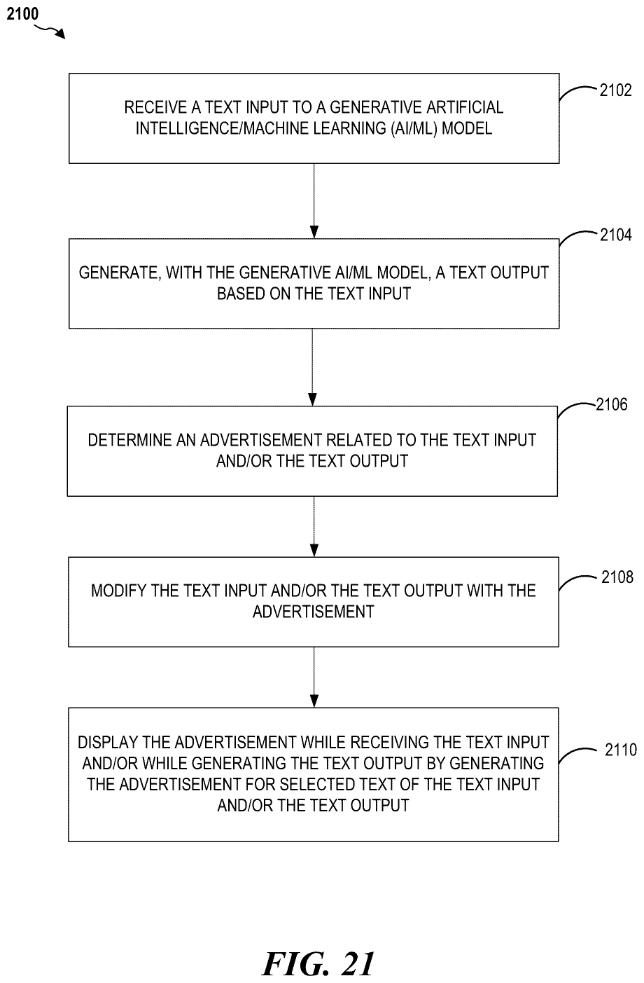

FIG. 21 is a flow diagram illustrating a processor-implemented method 2100 for advertisement matching for generative AI/ML models, in accordance with various aspects of the present disclosure. The processor-implemented method 2100 may be performed by one or more processors such as the CPU (e.g., 102, 422), GPU (e.g., 104, 426), and/or other processing unit (e.g., DSP 424, NPU 428), for example. As shown in FIG. 21, in some aspects, the processor-implemented method 2100 may include receiving a text input to a generative artificial intelligence/machine learning (AI/ML) model (block 2102). For example, a secondary AI/ML model may modify (or update) the text input to include the advertisement before the text input is received at the generative AI/ML model.

In some aspects, the processor-implemented method 2100 may include generating, with the generative AI/ML model, a text output based on the text input (block 2104). For example, the method may receive the text output at a secondary AI/ML model and modifying the text output at the secondary AI/ML model.

In some aspects, the processor-implemented method 2100 may include determining an advertisement related to the text input and/or the text output (block 2106). For example, the method may determine the advertisement related to the text input and/or the text output with a secondary AI/ML model.

In some aspects, the processor-implemented method 2100 may include modifying the text input and/or the text output with the advertisement (block 2108). For example, a secondary AI/ML model may modify the text input to include the advertisement before the text input is received at the generative AI/ML model.

In some aspects, the processor-implemented method 2100 may include displaying the advertisement while receiving the text input and/or while generating the text output by generating the advertisement for selected text of the text input and/or the text output (block 2110).

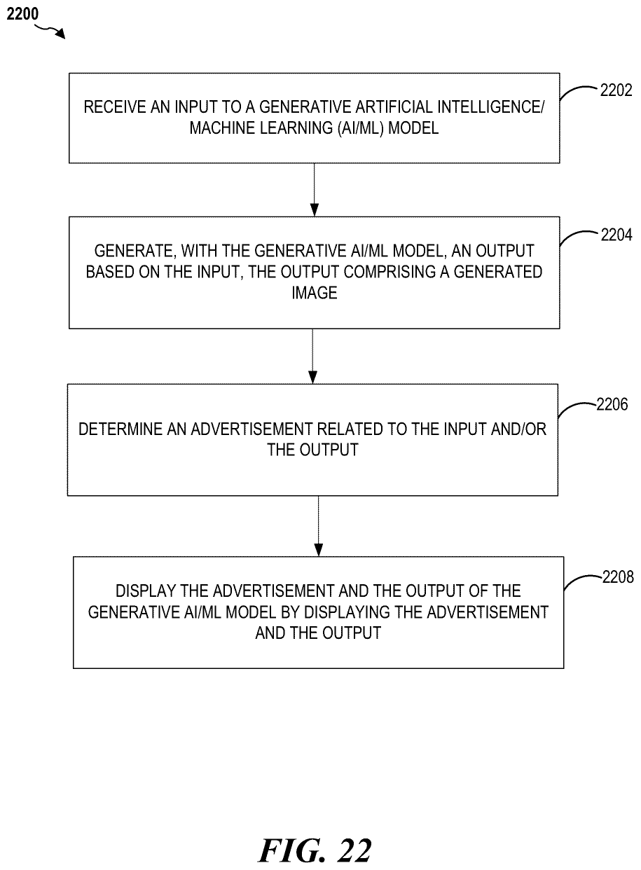

FIG. 22 is a flow diagram illustrating a processor-implemented method 2200 for advertisement matching for generative AI/ML models, in accordance with various aspects of the present disclosure. The processor-implemented method 2200 may be performed by one or more processors such as the CPU (e.g., 102, 422), GPU (e.g., 104, 426), and/or other processing unit (e.g., DSP 424, NPU 428), for example.

In some aspects, the processor-implemented method 2200 may include receiving an input to a generative artificial intelligence/machine learning (AI/ML) model (block 2202). For example, a secondary AI/ML model may modify the input to include the advertisement before the text input is received at the generative AI/ML model.

In some aspects, the processor-implemented method 2200 may include generating, with the generative AI/ML model, an output based on the input, the output comprising a generated image (block 2204). For example, the output may be received at a secondary AI/ML model and modified by the secondary AI/ML model.

In some aspects, the processor-implemented method 2200 may include determining an advertisement related to the input and/or the output (block 2206). For example, the method may determine the advertisement related to the input and/or the output with a secondary AI/ML model.

In some aspects, the processor-implemented method 2200 may include displaying the advertisement and the output of the generative AI/ML model by displaying the advertisement and the output (block 2208). For example, the first image may be a first video and the generated image may be a second video. The method may display the advertisement during a super zoom operation and/or inject the advertisement by performing an in-painting operation.

### EXAMPLE ASPECTS

Aspect 1: An apparatus, comprising: at least one memory; and at least one processor coupled to the at least one memory, the at least one processor configured to: receive a text input to a generative artificial intelligence/machine learning (AI/ML) model; generate, with the generative AI/ML model, a text output based on the text input; determine an advertisement related to the text input and/or the text output; modify the text input and/or the text output with the advertisement; and display the advertisement while receiving the text input and/or while generating the text output by generating the advertisement for selected text of the text input and/or the text output.

Aspect 2: The apparatus of Aspect 1, in which the at least one processor is further configured to determine the advertisement related to the text input and/or the text output with a secondary AI/ML model.

Aspect 3: The apparatus of Aspect 1 or 2, in which the generative AI/ML model includes the secondary AI/ML model.

Aspect 4: The apparatus of any of the preceding Aspects, in which the secondary AI/ML model resides on an edge device and the generative AI/ML model resides in a cloud network.

Aspect 5: The apparatus of Aspects 1-3, in which the secondary AI/ML model and the generative AI/ML model reside in a cloud network.

Aspect 6: The apparatus of any of the preceding Aspects, in which the secondary AI/ML model modifies the text input to include the advertisement before the text input is received at the generative AI/ML model.

Aspect 7: The apparatus of any of the preceding Aspects, in which the at least one processor is further configured to receive the text output at the secondary AI/ML model and modifying the text output at the secondary AI/ML model.

Aspect 8: The apparatus of any of the preceding Aspects, in which the at least one processor is further configured to generate, with the secondary AI/ML model, an additional advertisement that is related to the advertisement; and displaying the additional advertisement along with the advertisement, while receiving the text input and/or while generating the text output.

Aspect 9: The apparatus of any of the preceding Aspects, in which the at least one processor is further configured to: generate with the generative AI/ML model an additional output; determine, with the secondary AI/ML model, an additional advertisement related to the text input and/or the text output; modify the additional output with the additional advertisement; and display the additional advertisement while generating the additional output.

Aspect 10: The apparatus of any of the preceding Aspects, in which the at least one processor is further configured to receive training input for training the secondary AI/ML model, the training input comprising a brand name and an associated set of terms and/or phrases for training the secondary AI/ML model.

Aspect 11: The apparatus of any of the preceding Aspects, in which the training input further comprises weights of each term and/or phrase of the set of terms and/or phrases.

Aspect 12: The apparatus of any of the preceding Aspects, in which the at least one processor is further configured to prevent displaying of the advertisement in response to detecting a blacklisted topic in the text input and/or the text output.

Aspect 13: The apparatus of any of the preceding Aspects, in which the at least one processor is further configured to receive, at the generative AI/ML model, the advertisement in addition to the text input.

Aspect 14: The apparatus of any of the preceding Aspects, in which the at least one processor is further configured to display an indication of the advertisement along with the advertisement.

Aspect 15: The apparatus of any of the preceding Aspects, in which the at least one processor is further configured to block the advertisement from displaying.

Aspect 16: The apparatus of any of the preceding Aspects, in which the at least one processor is further configured to modify at least one of a temperature parameter, a Top P parameter, or a penalty for the advertisement in response to a weight assigned to an advertiser sponsoring the advertisement.

Aspect 17: The apparatus of any of the preceding Aspects, in which the at least one processor is further configured to determine the advertisement based on user spatio-temporal context.

Aspect 18: The apparatus of any of the preceding Aspects, in which the at least one processor is further configured to modify the text input and/or the text output based on a frequency penalty and/or a presence penalty.

Aspect 19: The apparatus of any of the preceding Aspects, in which the at least one processor is further configured to track usage of the advertisement.

Aspect 20: A processor-implemented method, comprising: receiving a text input to a generative artificial intelligence/machine learning (AI/ML) model; generating, with the generative AI/ML model, a text output based on the text input; determining an advertisement related to at least one of the text input or the text output; modifying at least one of the text input or the text output with the advertisement; and displaying the advertisement at least one of while receiving the text input or while generating the text output by generating the advertisement for selected text of at least one of the text input at least one of or the text output.

Aspect 21: An apparatus, comprising: at least one memory; and at least one processor coupled to the at least one memory, the at least one processor configured to: receive an input to a generative artificial intelligence/machine learning (AI/ML) model; generate, with the generative AI/ML model, an output based on the input, the output comprising a generated image; determine an advertisement related to the input and/or the output; and display the advertisement and the output of the generative AI/ML model by displaying the advertisement and the output.

Aspect 22: The apparatus of Aspect 21, in which the advertisement comprises a first video and the generated image comprises a second video.

Aspect 23: The apparatus of Aspect 21 or 22, in which the at least one processor is further configured to display the advertisement during a super zoom operation.

Aspect 24: The apparatus of any of the Aspects 21-23, in which the at least one processor is further configured to inject the advertisement by performing an in-painting operation.

Aspect 25: The apparatus of any of the Aspects 21-24, in which the at least one processor is further configured to determine the advertisement related to the input and/or the output with a secondary AI/ML model.

Aspect 26: The apparatus of any of the Aspects 21-25, in which the at least one processor is further configured to receive training input for training the secondary AI/ML model, the training input comprising a brand name and an associated set of images, terms and/or phrases for training the secondary AI/ML model.

Aspect 27: The apparatus of any of the Aspects 21-26, in which the generative AI/ML model includes the secondary AI/ML model.

Aspect 28: The apparatus of any of the Aspects 21-27, in which the secondary AI/ML model resides on an edge device and the generative AI/ML model resides in a cloud network.

Aspect 28: The apparatus of any of the Aspects 21-27, in which the secondary AI/ML model and the generative AI/ML model reside in a network cloud.

Aspect 30: The apparatus of any of the Aspects 21-29, in which the secondary AI/ML model modifies the input to include the advertisement before the input is received at the generative AI/ML model.

Aspect 31: The apparatus of any of the Aspects 21-30, in which the at least one processor is further configured to receive the output at the secondary AI/ML model and modifying the output at the secondary AI/ML model.

Aspect 32: The apparatus of any of the Aspects 21-31, in which the at least one processor is further configured to generate, with the secondary AI/ML model, an additional advertisement that is related to the advertisement; and displaying the additional advertisement along with the advertisement, while receiving the input and/or while generating the output.

Aspect 33: The apparatus of any of the Aspects 21-32, in which the at least one processor is further configured to: generate, with the generative AI/ML model, an additional output; determine, with the secondary AI/ML model, an additional advertisement related to the input and/or the output; modify the additional output with the additional advertisement; and display the additional advertisement while generating the additional output.

Aspect 34: The apparatus of any of the Aspects 21-33, in which the at least one processor is further configured to receive at the generative AI/ML model, the advertisement in addition to the input.

Aspect 35: The apparatus of any of the Aspects 21-34, in which the at least one processor is further configured to prevent displaying of the advertisement in response to detecting a blacklisted topic in the input and/or the output.

Aspect 36: The apparatus of any of the Aspects 21-35, in which the at least one processor is further configured to display an indication of the advertisement along with the advertisement.

Aspect 37: The apparatus of any of the Aspects 21-36, wherein displaying the advertisement and the output comprises inserting the advertisement into the output as a first image.

Aspect 38: A processor-implemented method, comprising: receiving an input to a generative artificial intelligence/machine learning (AI/ML) model; generating, with the generative AI/ML model, an output based on the input, the output comprising a generated image; determining an advertisement related to the input and/or the output; and displaying the advertisement and the output of the generative AI/ML model by displaying the advertisement and the output.

Aspect 39: The processor-implemented method of Aspect 38, in which the advertisement comprises a first video and the generated image comprises a second video.

Aspect 40: The processor-implemented method of Aspect 38 or 39, further comprising displaying the advertisement during a super zoom operation.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

The invention claimed is:

1. An apparatus, comprising:
at least one memory; and
at least one processor coupled to the at least one memory, the at least one processor configured to:
receive an input to a generative artificial intelligence/machine learning (AI/ML) model;
generate, with the generative AI/ML model, an output based on the input, the output comprising a generated image;
determine an advertisement related to at least one of the input or the output; and
display the advertisement and the output of the generative AI/ML model by displaying the advertisement and the output.

2. The apparatus of claim 1, in which the advertisement comprises a first video and the generated image comprises a second video.

3. The apparatus of claim 1, in which the at least one processor is further configured to display the advertisement during a super zoom operation.

4. The apparatus of claim 1, in which the at least one processor is further configured to inject the advertisement by performing an in-painting operation.

5. The apparatus of claim 1, in which the at least one processor is further configured to determine the advertisement related to at least one of the input or the output with a secondary AI/ML model.

6. The apparatus of claim 5, in which the at least one processor is further configured to receive training input for training the secondary AI/ML model, the training input comprising a brand name and an associated set of at least one of images, terms or phrases for training the secondary AI/ML model.

7. The apparatus of claim 5, in which the generative AI/ML model includes the secondary AI/ML model.

8. The apparatus of claim 5, in which the secondary AI/ML model resides on an edge device and the generative AI/ML model resides in a cloud network.

9. The apparatus of claim 5, in which the secondary AI/ML model and the generative AI/ML model reside in a network cloud.

10. The apparatus of claim 5, in which the secondary AI/ML model modifies the input to include the advertisement before the input is received at the generative AI/ML model.

11. The apparatus of claim 5, in which the at least one processor is further configured to:
receive the output at the secondary AI/ML model; and
modify the output at the secondary AI/ML model.

12. The apparatus of claim 5, in which the at least one processor is further configured to:
generate, with the secondary AI/ML model, an additional advertisement that is related to the advertisement; and
display the additional advertisement along with the advertisement, at least one of while receiving the input or while generating the output.

13. The apparatus of claim 5, in which the at least one processor is further configured to:
generate, with the generative AI/ML model, an additional output;
determine, with the secondary AI/ML model, an additional advertisement related to at least one of the input or the output;
modify the additional output with the additional advertisement; and
display the additional advertisement while generating the additional output.

14. The apparatus of claim 1, in which the at least one processor is further configured to receive at the generative AI/ML model, the advertisement in addition to the input.

15. The apparatus of claim 1, in which the at least one processor is further configured to prevent displaying of the advertisement in response to detecting a blacklisted topic in at least one of the input or the output.

16. The apparatus of claim 1, in which the at least one processor is further configured to display an indication of the advertisement along with the advertisement.

17. The apparatus of claim 1, wherein displaying the advertisement and the output comprises inserting the advertisement into the output as a first image.

18. A processor-implemented method, comprising:
receiving an input to a generative artificial intelligence/machine learning (AI/ML) model;
generating, with the generative AI/ML model, an output based on the input, the output comprising a generated image;
determining an advertisement related to at least one of the input or the output; and
displaying the advertisement and the output of the generative AI/ML model by displaying the advertisement and the output.

19. The processor-implemented method of claim 18, in which the advertisement comprises a first video and the generated image comprises a second video.

20. The processor-implemented method of claim 18, further comprising displaying the advertisement during a super zoom operation.
